(19) United States
(12) Patent Application Publication
(10) Pub. No.: US 2025/0322609 A1
(43) Pub. Date: Oct. 16, 2025

(54) MESH DIFFERENCE ESTIMATION FROM TRUNCATED SIGNED DISTANCES

(71) Applicant: QUALCOMM Incorporated, San Diego, CA (US)

(72) Inventors: Pirazh KHORRAMSHAHI, San Diego, CA (US); Gokce DANE, San Diego, CA (US); Upal MAHBUB, Santee, CA (US); Adithya Reddy NALLABOLU, San Diego, CA (US)

(21) Appl. No.: 18/800,772

(22) Filed: Aug. 12, 2024

Related U.S. Application Data
(60) Provisional application No. 63/632,918, filed on Apr. 11, 2024.

(51) Int. Cl. G06T 17/20

(52) U.S. Cl. CPC G06T 17/20

(57) ABSTRACT

Systems and techniques are described for performing three-dimensional (3D) mesh reconstruction of a scene. In some examples, a system selects a plurality of voxel blocks for the scene based on depth data and pose data. The pose data is indicative of a perspective of the depth data. The system generates a truncated signed distance function (TSDF) value based on the depth data. The TSDF value corresponds to at least one voxel in the plurality of voxel blocks. The system compares the TSDF value to a previous TSDF value to estimate a vertex difference. The system determines, based on a comparison between the vertex difference and a threshold, whether to generate a mesh based on the TSDF value. In some examples, the system maintains a previous mesh in memory if the threshold exceeds the vertex difference, or generates the mesh if the vertex difference exceeds the threshold.

### FIELD

This application claims the benefit of U.S. Provisional Application No. 63/632,918, filed Apr. 11, 2024, and titled “Mesh Difference Estimation from Truncated Signed Distances,” which is hereby incorporated by reference in its entirety and for all purposes.

### FIELD

The present disclosure generally relates to image processing. For example, aspects of the present disclosure relate to voxel block selection, depth integration, and selective surface extraction based on change detection.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Traditional systems for constructing 3D models use a significant amount of computational resources, memory, and bandwidth, and in some cases generate significant heat in the process. In recent decades, there has been a demand for 3D content for computer graphics, virtual reality, and communications. Recent decades have also shown a demand for performing more computing tasks on portable computing devices rather than bulky stationary computing systems.

### SUMMARY

Systems and techniques are described for performing three-dimensional (3D) mesh reconstruction of a scene. In some examples, a system selects a plurality of voxel blocks for the scene based on depth data and pose data. The pose data is indicative of a perspective of the depth data. The system generates a truncated signed distance function (TSDF) value based on the depth data. The TSDF value corresponds to at least one voxel in the plurality of voxel blocks. The system compares the TSDF value to a previous TSDF value to estimate a vertex difference. The previous TSDF value is based on previous depth data and previous pose data. The previous TSDF value is associated with a previous mesh of the scene. The system determines, based on a comparison between the vertex difference and a threshold, whether to generate a mesh based on the TSDF value. In some examples, the comparison indicates that the vertex difference is greater than the threshold, and the system generates the mesh based on the TSDF value in response to the comparison. In some examples, the comparison indicates that the vertex difference is less than the threshold, and the system maintain the previous mesh of the scene in memory without generating the mesh based on the TSDF value in response to the comparison.

In one example, an apparatus for three-dimensional reconstruction (3DR) of a scene is provided. The apparatus includes a memory and one or more processors (e.g., implemented in circuitry) coupled to the memory. The one or more processors are configured to and can: select a plurality of voxel blocks for the scene based on depth data and pose data, wherein the pose data is indicative of a perspective of the depth data; generate a truncated signed distance function (TSDF) value based on the depth data, wherein the TSDF value corresponds to at least one voxel in the plurality of voxel blocks; compare the TSDF value to a previous TSDF value to estimate a vertex difference; and determine, based on a comparison between the vertex difference and a threshold, whether to generate a mesh based on the TSDF value.

In another example, a method for three-dimensional reconstruction (3DR) of a scene is provided. The method includes: selecting a plurality of voxel blocks for the scene based on depth data and pose data, wherein the pose data is indicative of a perspective of the depth data; generating a truncated signed distance function (TSDF) value based on the depth data, wherein the TSDF value corresponds to at least one voxel in the plurality of voxel blocks; comparing the TSDF value to a previous TSDF value to estimate a vertex difference; and determining, based on a comparison between the vertex difference and a threshold, whether to generate a mesh based on the TSDF value.

In another example, a non-transitory computer-readable medium is provided that has stored thereon instructions that, when executed by one or more processors, cause the one or more processors to: select a plurality of voxel blocks for a scene based on depth data and pose data, wherein the pose data is indicative of a perspective of the depth data; generate a truncated signed distance function (TSDF) value based on the depth data, wherein the TSDF value corresponds to at least one voxel in the plurality of voxel blocks; compare the TSDF value to a previous TSDF value to estimate a vertex difference; and determine, based on a comparison between the vertex difference and a threshold, whether to generate a mesh based on the TSDF value.

In another example, an apparatus for three-dimensional reconstruction (3DR) of a scene is provided. The apparatus includes: means for selecting a plurality of voxel blocks for the scene based on depth data and pose data, wherein the pose data is indicative of a perspective of the depth data; means for generating a truncated signed distance function (TSDF) value based on the depth data, wherein the TSDF value corresponds to at least one voxel in the plurality of voxel blocks; means for comparing the TSDF value to a previous TSDF value to estimate a vertex difference; and means for determining, based on a comparison between the vertex difference and a threshold, whether to generate a mesh based on the TSDF value.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus includes an image sensor (e.g., a camera) or multiple image sensors (e.g., multiple cameras) for capturing one or more images. In some aspects, each apparatus includes one or more displays for displaying one or more images, notifications, and/or other displayable data. In some aspects, each apparatus includes one or more speakers, one or more light-emitting devices, and/or one or more microphones. In some aspects, each apparatus described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram illustrating an example device that may employ a color metadata buffer for 3D reconstruction, in accordance with some examples.

FIG. 4 is a diagram illustrating an example of a 3D surface reconstruction of a scene modeled as a volume grid, in accordance with some examples.

FIG. 5 is a diagram illustrating an example of a hash mapping function for indexing blocks (e.g., voxel blocks) in a volume grid, in accordance with some examples.

FIG. 6 is a diagram illustrating an example of a block (e.g., a voxel block), in accordance with some examples.

FIG. 7 is a diagram illustrating an example of a truncated signed distance function (TSDF) volume reconstruction, in accordance with some examples.

FIG. 8 is a diagram illustrating an example of a voxel block selection algorithm, in accordance with some examples.

FIG. 9 is a diagram illustrating an example of a scalable voxel block selection algorithm that utilizes a fixed block configuration, in accordance with some examples.

FIG. 10 is a flow diagram illustrating an example of a process for operation of the scalable voxel block selection algorithm of FIG. 9, in accordance with some examples.

FIG. 11 is a table illustrating examples of different voxel block configurations with corresponding hardware cache requirements, in accordance with some examples.

FIG. 12 is a diagram illustrating an example of a scalable voxel block selection algorithm that utilizes a fixed block configuration, where an example of a fixed block configuration and an example of a particular block configuration are illustrated, in accordance with some examples.

FIG. 13 is a flow diagram illustrating a process for generating a 3D mesh of a scene based on a depth map and a pose, in accordance with some examples.

FIG. 14 is a flow diagram illustrating a process for determining whether to generate a new 3D mesh of a scene based on whether a significant change is detected between a truncated signed distance function (TSDF) value and a previous TSDF value, in accordance with some examples.

FIG. 15 is a conceptual diagram illustrating representations of the vertices and edges of a polygon (e.g., a cube), in accordance with some examples.

FIG. 16 is a conceptual diagram illustrating representations of representations of surface extraction and mesh generation at a voxel level, in accordance with some examples.

FIG. 17 is a block diagram illustrating a neural network architecture for comparing updated truncated signed distance function (TSDF) values and previous TSDF values to identify a vertex difference, in accordance with some examples.

FIG. 18 is a block diagram illustrating a neural network architecture for comparing the updated truncated signed distance function (TSDF) values and the previous TSDF values to identify a vertex difference, with the neural network architecture including a marching cube case classification loss function, in accordance with some examples.

FIG. 19 is a graph diagram illustrating a histogram of density against marching cube case label, in accordance with some examples.

FIG. 20 is a graph diagram illustrating graphs of absolute changes in truncated signed distance function (TSDF) value relative to number of times voxel TSDF values are updated, in accordance with some examples.

FIG. 21 is a graph diagram illustrating graphs for actual vertex distance (d*) and vertex distance estimation error (|\hat{d}−d*|₁), in accordance with some examples.

FIG. 22 is a heat map diagram illustrating true label for a given voxel relative to predicted label for the given voxel, in accordance with some examples.

FIG. 23 is a block diagram illustrating an example of a neural network that can be used for 3D mesh reconstruction, in accordance with some examples.

FIG. 24 is a flow diagram illustrating an example of a process for 3D reconstruction of a scene, in accordance with some examples.

FIG. 25 is a block diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

In block selection, depth pixels can be iterated over to unproject them to a 3D space and determine where they lie within the 3D space using intrinsic and extrinsic camera parameters. Typically, a hash map is employed for block selection. A hash map is an unordered map that includes a listing of blocks (e.g., including block indices of the blocks) that have a surface. The hash map can include a corresponding counter for each of the blocks that maintains a count of the number of times depth pixels lie within the particular block. A threshold (e.g., threshold value or number) can be used to select all the blocks that have depth pixels lie within them for more than the threshold number of times. The selected blocks can then be integrated. The cache size (e.g., size of the hardware for the cache memory, which can be used to store the hash map) can depend upon the depth range, sample distances, block size, etc.

In one or more aspects, systems, apparatuses, processes (also referred to as methods), and computer-readable media (collectively referred to herein as “systems and techniques”) are described herein for three-dimensional (3D) mesh reconstruction of a scene. In some examples, a system selects a plurality of voxel blocks for the scene based on depth data and pose data. The pose data is indicative of a perspective of the depth data. The system generates a truncated signed distance function (TSDF) value based on the depth data. The TSDF value corresponds to at least one voxel in the plurality of voxel blocks. The system compares the TSDF value to a previous TSDF value to estimate a vertex difference. The previous TSDF value is based on previous depth data and previous pose data. The previous TSDF value is associated with a previous mesh of the scene. The system determines, based on a comparison between the vertex difference and a threshold, whether to generate a mesh based on the TSDF value. In some examples, the comparison indicates that the vertex difference is greater than the threshold, and the system generates the mesh based on the TSDF value in response to the comparison. In some examples, the comparison indicates that the vertex difference is less than the threshold, and the system maintain the previous mesh of the scene in memory without generating the mesh based on the TSDF value in response to the comparison.

The systems and techniques provide a number of advantages. For example, the systems and techniques allow for a scalable hardware 3DR system. The systems and techniques improve efficiency of performing 3D mesh reconstruction of a scene, for instance by reducing usage of computational resources, memory, bandwidth, and battery draw, and thus saving battery life and preserving computational resources, memory, bandwidth, and the like. Keeping device temperature below certain threshold levels is also important for portable devices, especially for wearable devices, to avoid burning the user or providing discomfort to the user. The systems and techniques can help such devices reduce heat generation while performing 3D mesh reconstruction by periodically skipping computationally-intensive surface extraction processes (e.g., marching cube algorithm) that might otherwise cause the device to generate significant amounts of heat. High levels of heat can also reduce performance of certain device components, so the systems and techniques improve overall performance of a device that performs 3D mesh reconstruction by keeping heat low. Heat dissipation components (e.g., heat sinks, fans, coolant-based coolers and/or other cooling mechanisms) can be large. For instance, even passive heat sinks work by increasing surface area that is in contact with air or another cooling medium. Thus, the systems and techniques can reduce the size of a device by reducing need for heat dissipation components. Some heat dissipation components, such as fans or coolant-based coolers, can require power to function and therefore increase power draw. Thus, the systems and techniques can reduce a device's power draw further by reducing need for heat dissipation components.

Additional aspects of the present disclosure are described in more detail below.

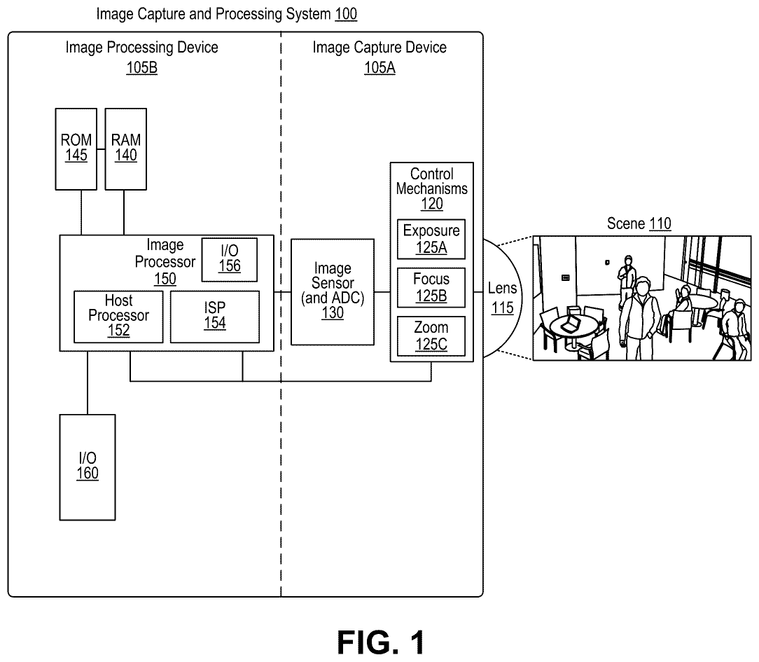

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 2510 discussed with respect to the computing system 2500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2520, read-only memory (ROM) 145/2525, a cache 2512, a memory unit 2515, another storage device 2530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 2535, any other input devices 2545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

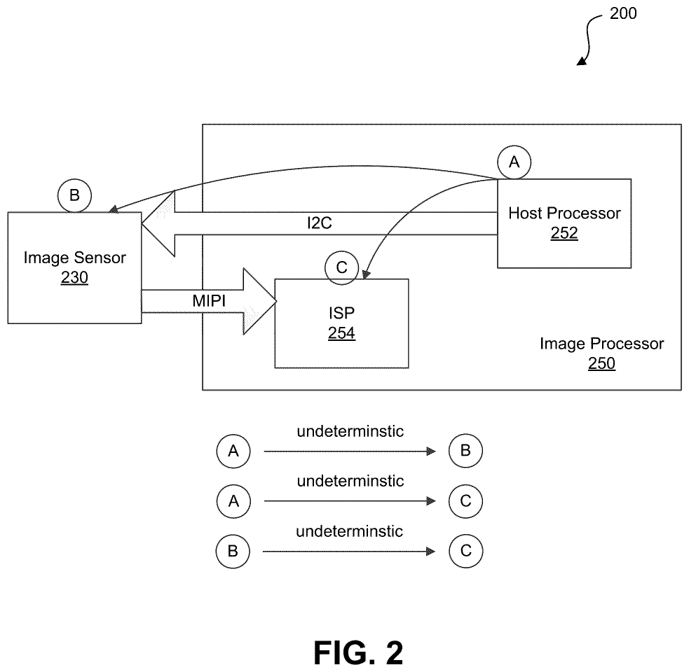

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

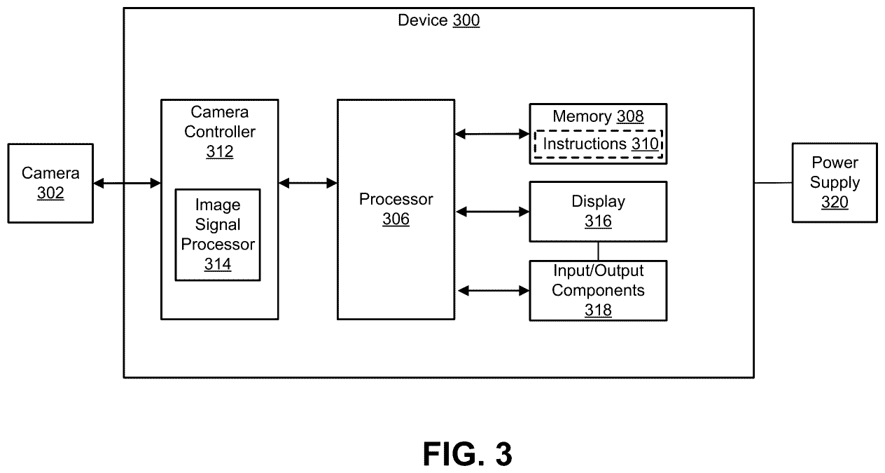

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

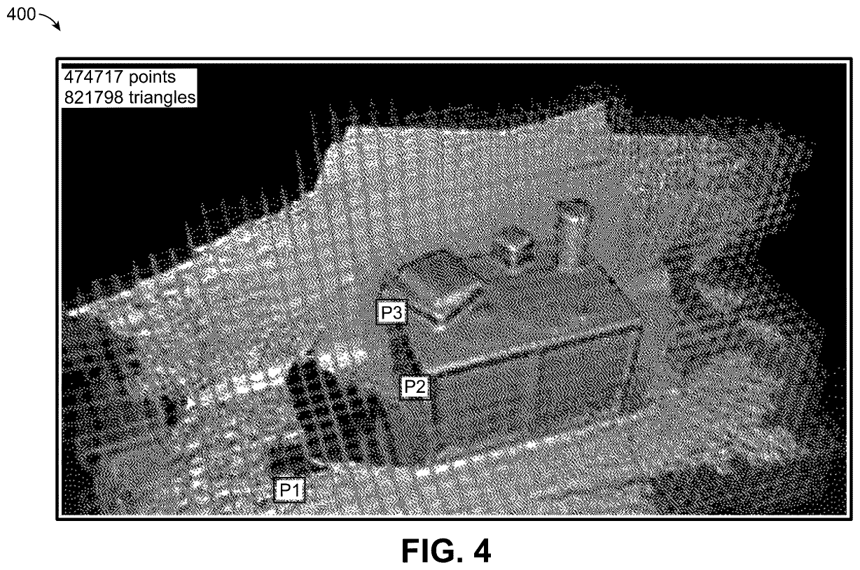

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

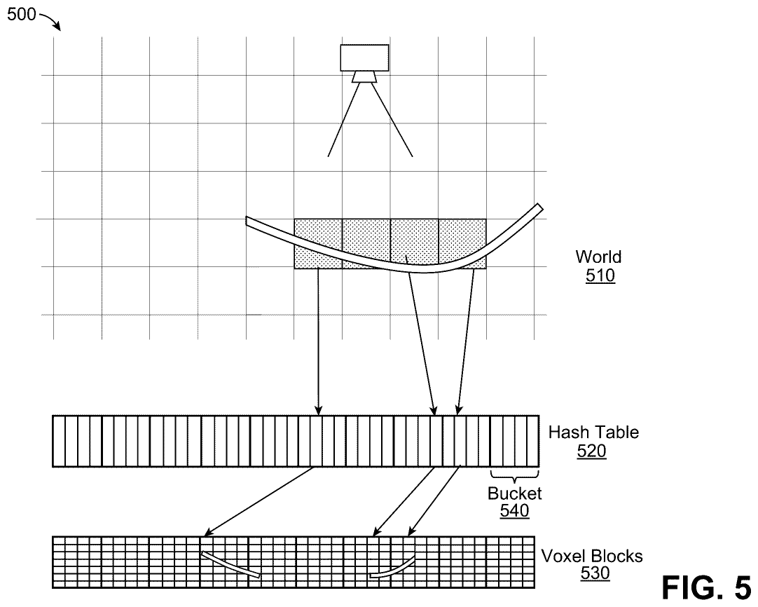

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

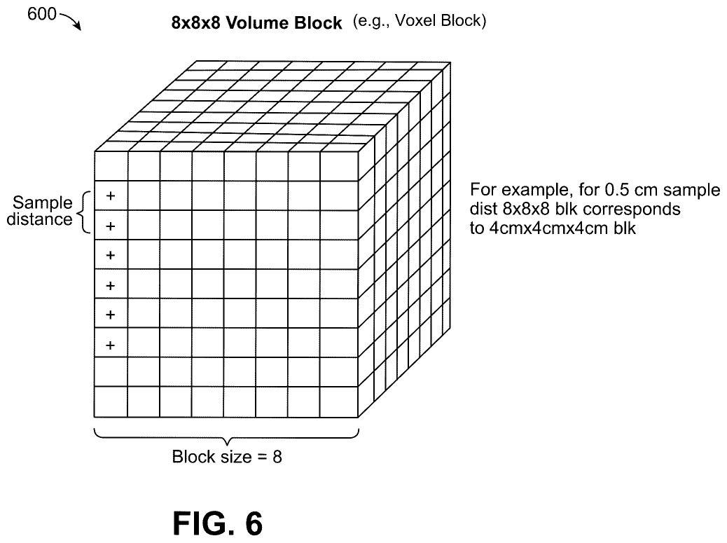

FIG. 6 is a diagram illustrating an example of a volume block (e.g., a voxel block) 600. In FIG. 6, the voxel block 600 is shown to have a block size of eight. For example, a 0.5 centimeter (cm) sample distance for an eight by eight by eight voxel block can correspond to a four cm by four cm by four cm voxel block. That is, the voxel block 600 includes a 3D lattice of 512 voxels, the voxels arranged so that the voxel block 600 has a width of 8 voxels, a length of 8 voxels, and a height of 8 voxels.

In one or more examples, each voxel block (e.g., voxel block 600) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$tsdf = \{ \begin{matrix}- 1 , & if d \leq - ramp \\ \frac{d}{ramp} , & if - ramp < d < \\ 1 , & if d \geq ramp\end{matrix} ramp \} \qquad Equation ( 1 )$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

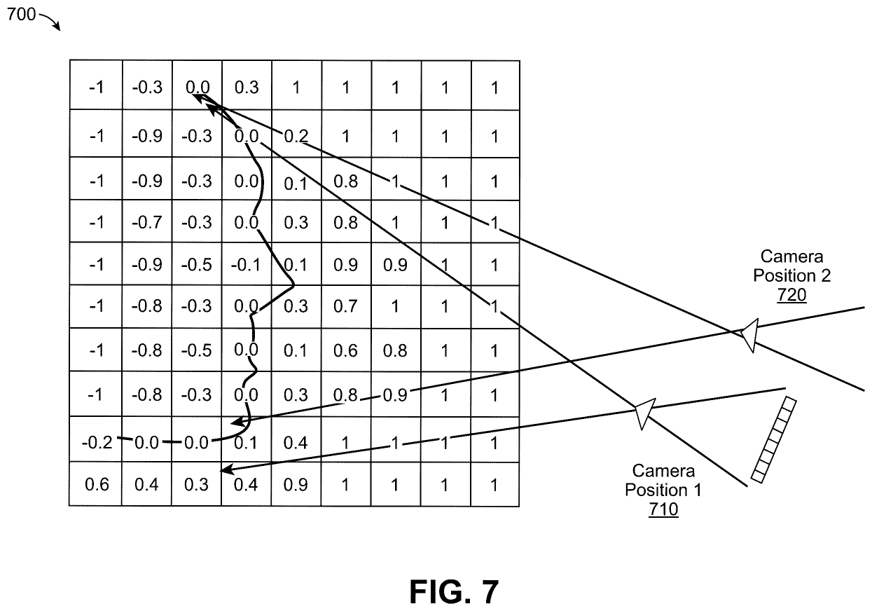

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

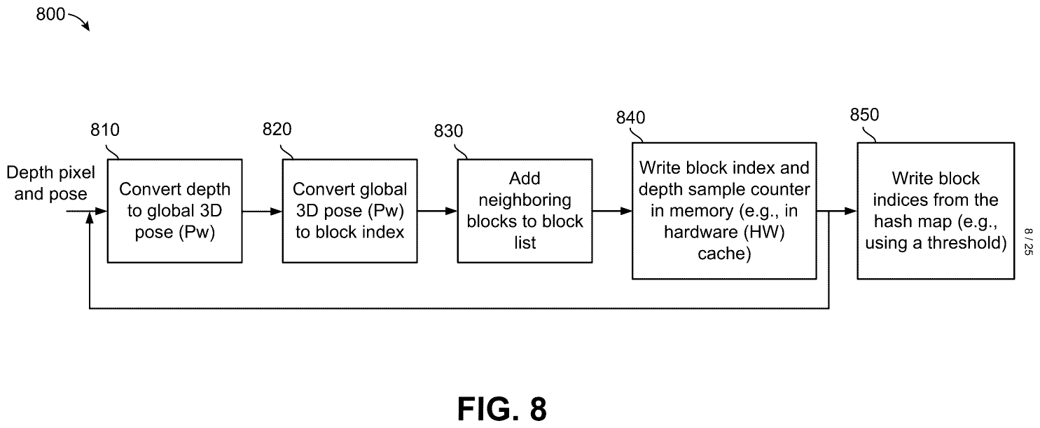

FIG. 8 shows an example voxel block selection algorithm for 3DR of a scene. In particular, FIG. 8 is a diagram illustrating an example of a voxel block selection algorithm 800. In FIG. 8, for operation of the voxel block selection algorithm 800, a plurality of depth pixels associated with a plurality of depth maps of the scene can be obtained by one or more processors (e.g., ISP 154 of FIG. 1, ISP 254 of FIG. 2, and/or image signal processor 314 of FIG. 3). In one or more examples, each depth map of the plurality of depth maps is associated with a respective pose (e.g., 6 DoF pose) of an image sensor (e.g., a camera, such as image capture device 105A, image sensor 230 of FIG. 2, or camera 302 of FIG. 3). In some examples, each depth pixel of the plurality of depth pixels is associated with a depth value. The one or more processors can iterate the algorithm 800 over every depth value in the depth maps.

During operation of the voxel block selection algorithm 800, at operation 810, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space.

At operation 810, the one or more processors can determine indices of blocks (e.g., voxel blocks) associated with the plurality of global 3D points. At operation 830, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at operation 840, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At operation 850, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

The cache size (e.g., size of the hardware for the cache memory, which may store the hash map) can depend upon the depth range, sample distances, block size, etc. The requirement for the cache size (e.g., requirement for the size of the hardware for the cache) can increase with cubic order with an increase in sample distances and/or block sizes, and may be significantly large, especially for smaller sample distances and/or smaller block sizes. Thus, the requirement for the cache size (e.g., for storing the hash map) may be a bottleneck for the operation of a block selection algorithm for block selection. With a finite hardware cache size (e.g., for storing the hash map), there can be a strong probability for collisions and overflow of the hash index array, which may force block indices to be dropped (e.g., deleted from the cache). When block indices are dropped, an unpleasant randomness may be induced in the block selection algorithm because the outputs of the algorithm may not be consistent. To eliminate this randomness, a large overflow buffer (e.g., which is not scalable) can be required. Current 3DR hardware algorithms are not flexible to support all 3DR configurations with a limited cache size. Therefore, systems and techniques to provide a scalable block selection algorithm with a finite hardware cache size can be useful.

In one or more aspects, the systems and techniques provide a scalable voxel block selection algorithm with a finite hardware cache. In one or more examples, for 3DR, in block selection, blocks can be selected that have surfaces inside or close to the block volumes. Since 3DR algorithms operate with varying 3DR configurations, hardware needs to be designed to support all these configurations. The systems and techniques provide a scalable efficient hardware block selection algorithm, which can support all 3DR block configurations with a finite cache size.

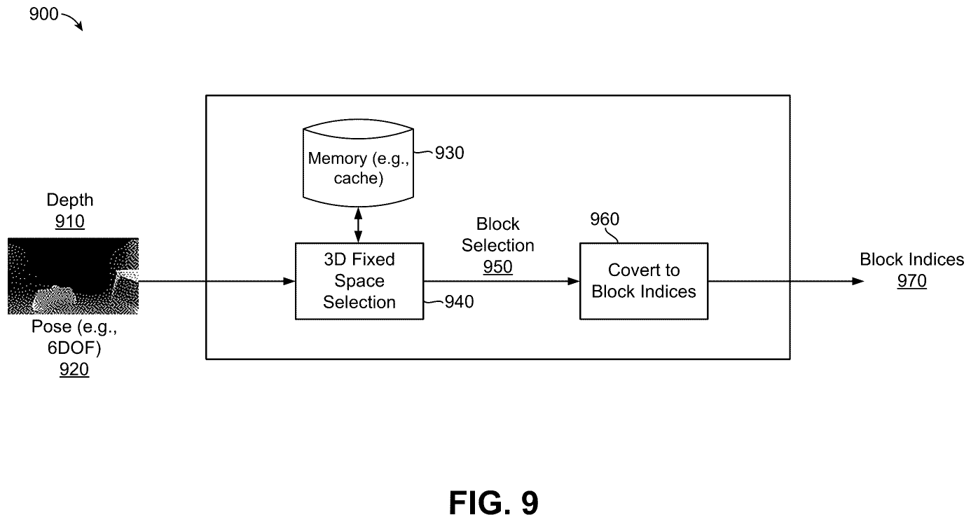

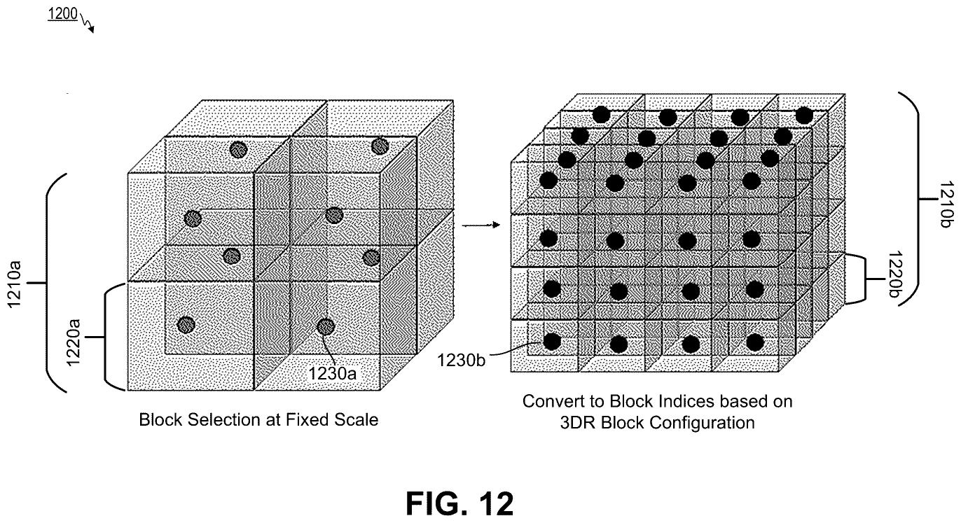

In one or more aspects, the systems and techniques provide a modified voxel block selection algorithm. Instead of selecting block volumes with varying 3DR configurations (e.g., as typically performed by existing block selection algorithms, such as the voxel block selection algorithm 800 of FIG. 8), the systems and techniques provide a block selection algorithm (e.g., voxel block selection algorithm 900 of FIG. 9 and voxel block selection algorithm of FIG. 12) that selects a 3D space using a fixed configuration (e.g., the configuration for voxel block 1210a as shown in FIG. 12). In some cases, the fixed configuration can be determined or selected from a number of available fixed configurations. By using the selected 3D space with a fixed configuration, selected block indices can be converted utilizing a simple conversion based on the 3DR configuration (e.g., a desired use case 3DR configuration for a particular 3DR application, such as the configuration for voxel block 1210b as shown in FIG. 12). Using a fixed configuration can remove the variable hardware cache requirement such that all 3DR block configurations may be supported.

Using a fixed configuration may allow for a hardware design (e.g., a cache hardware design) agnostic to the different 3DR block configurations, while being scalable to support multiple 3DR configurations. The hardware cache may be designed with a fixed configuration that can avoid overloading a hash index array with certainty. Using a fixed configuration may remove the unpleasant randomness in the output of the blocks selection algorithm. By operating a block selection algorithm with a fixed configuration, the uncertainty with a finite hash map may be removed and also the need for an overflow buffer can be eliminated. The use of a fixed configuration may incur a slight increase in the number of blocks integrated.

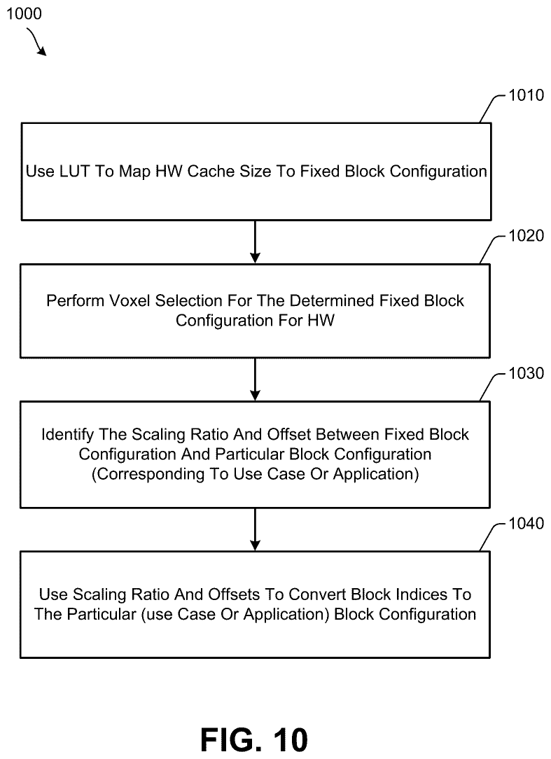

FIGS. 9 and 10 together illustrate operation of an example scalable voxel block selection algorithm 900. In particular, FIG. 9 is a diagram illustrating an example of a scalable voxel block selection algorithm 900 that utilizes a fixed block configuration. In FIG. 8, for operation of the voxel block selection algorithm 900, a plurality of depth pixels associated with a plurality of depth maps (e.g., depth map 910) of a scene can be obtained by one or more processors (e.g., ISP 154 of FIG. 1, ISP 254 of FIG. 2, and/or image signal processor 314 of FIG. 3). In one or more examples, each depth map of the plurality of depth maps is associated with a respective pose (e.g., 6 DoF pose, such as 6 DoF pose 920) of an image sensor (e.g., a camera, such as image capture device 105A, image sensor 230 of FIG. 2, or camera 302 of FIG. 3). In some examples, each depth pixel of the plurality of depth pixels is associated with a depth value.

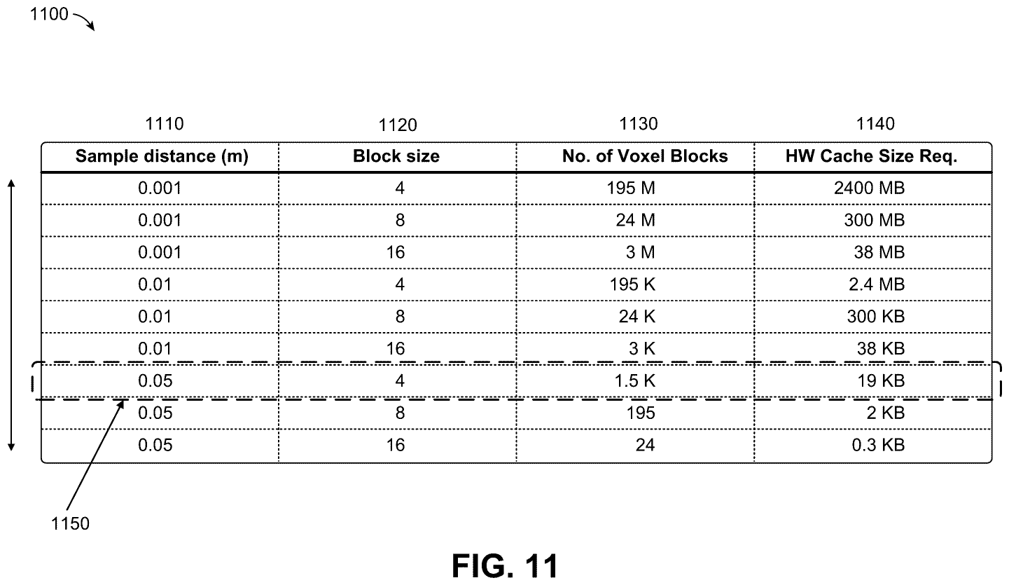

During operation of the scalable voxel block selection algorithm 900, at operation 940, the one or more processors can determine a fixed block configuration based on a storage size limitation. In one or more examples, the storage size limitation may be a cache size limitation (e.g., a limitation of the size of hardware required for the cache memory, such as cache 930). In some examples, the determining of the fixed block configuration by the one or more processors can be further based on a lookup table (LUT), such as table 1100 of FIG. 11, mapping the plurality of block configurations to associated respective required cache sizes, where the plurality of block configurations includes the fixed block configuration (e.g., such as configuration 1150 of FIG. 11).

During operation of the algorithm 900, at arrow 950, the one or more processors can select a plurality of blocks of the scene based on the fixed block configuration (e.g., the configuration of voxel block 1210a as shown in FIG. 12). Each block of the plurality of blocks may be a voxel block (e.g., voxel block 1210a of FIG. 12). The one or more processors can iterate over every depth value in the depth maps for the selection of the plurality of blocks. For the selection of the plurality of the blocks, the one or more processors may convert the depth values of the plurality of depth pixels to a plurality of global 3D points in a global coordinate system. The converting of the depth values of the plurality of depth pixels to the plurality of global 3D points in the global coordinate system may be achieved by the one or more processors unprojecting the depth values to a 3D space. The one or more processors can then determine indices of blocks (e.g., voxel blocks) associated with the plurality of global 3D points. The one or more processors may generate a listing of blocks including the indices of the blocks associated with the plurality of global 3D points and indices of neighboring blocks adjacent (e.g., next to or close) to the blocks associated with the plurality of global 3D points.

The one or more processors may then select the plurality of blocks of the scene from the listing of blocks based on a number of depth pixels of the plurality of depth pixels being located within the plurality of blocks. For an example, the one or more processors May increment a counter for each block in the listing of blocks each time a depth pixel of the plurality of depth pixels is located within each block. The one or more processors may then write the indices and the corresponding counter values of the blocks in the listing of the blocks in memory (e.g., a hardware cache, such as cache 930). The one or more processors may then determine blocks in the listing of blocks with a counter value greater than a threshold value (e.g., a threshold number). The one or more processors may then select the plurality of blocks of the scene based on the blocks in the listing of blocks with the counter value greater than the threshold value. The one or more processors may then write the indices of the selected plurality of blocks of the scene in memory (e.g., the hardware cache, such as cache 930).

At operation 960, the one or more processors can then convert indices of the plurality of blocks (e.g., voxel block 1210a of FIG. 12) associated with the fixed block configuration (e.g., the configuration of voxel block 1210a as shown in FIG. 12) to indices of a plurality of blocks (e.g., voxel block 1210b of FIG. 12) associated with a particular block configuration (e.g., the configuration of voxel block 1210b as shown in FIG. 12) of a plurality of block configurations (e.g., different voxel block configurations as shown in table 1100 of FIG. 11). The particular block configuration corresponds to a particular 3DR application (or use case) and is different from the fixed block configuration.

In one or more examples, a particular block configuration may be a desired block configuration for a specific 3DR use case or application. Different 3DR use cases/applications can require different block configurations. For example, a use case (e.g., an autonomous driving 3DR use case or application) that requires a high resolution for 3DR may require a block configuration with a small sample distance between samples (e.g., samples 1230b of FIG. 12) within a voxel block (e.g., voxel block 1210b of FIG. 12). A block configuration with a small sample distance can typically have a large cache size requirement.

In one or more examples, the one or more processors can determine a scaling ratio and offsets between the fixed block configuration (e.g., the configuration of voxel block 1210a as shown in FIG. 12) and the particular block configuration (e.g., the configuration of voxel block 1210b as shown in FIG. 12). In one or more examples, the converting, by the one or more processors, of the indices of the plurality of blocks associated with the fixed block configuration to the indices of the plurality of blocks associated with the particular block configuration can be based on the determined scaling ratio and the offsets between the fixed block configuration and the particular block configuration.

For an example of converting an index of a block associated with a fixed block configuration to an index of a block associated with a particular block configuration, a voxel block associated with a fixed block configuration may have an index (e.g., a block index) of {bx1, by1, bz1}. The one or more processors may utilize an upscaling ratio and offsets to convert the index of {bx1, by1, bz1} of the voxel block associated with the fixed block configuration to an index of {(2*bx1, 2*by1, 2*bz1), (2*bx1+1, 2*by1, 2*bz1), (2*bx1, 2*by1+1, 2*bz1), (2*bx1, 2*by1, 2*bz1+1)} of a voxel block associated with the particular block configuration.

After the one or more processors convert indices of the plurality of blocks associated with the fixed block configuration to indices of the plurality of blocks associated with the particular block configuration, the one or more processors can then write the indices of the plurality of blocks (e.g., block indices 970) of the particular block configuration in memory (e.g., the hardware cache, such as cache 930).

FIG. 10 is a flow diagram illustrating an example of a process 1000 for operation of the scalable voxel block selection algorithm 900 of FIG. 9. During operation of the process 1000 of FIG. 10, at step 1010, one or more processors (e.g., ISP 154 of FIG. 1, ISP 254 of FIG. 2, and/or image signal processor 314 of FIG. 3) can use a lookup table (e.g., table 1100 of FIG. 11) to map the hardware cache size (e.g., size of cache 930 of FIG. 9) to an affordable block configuration (e.g., a fixed block configuration that allows for block indices to be maintained, and not dropped). At operation 1020, the one or more processors can perform voxel block selection for the determined block configuration (e.g., the fixed block configuration) for the cache hardware. At operation 1030, the one or more processors can identify (e.g., determine) a scaling ratio and offsets between the supported block configuration (e.g., the fixed block configuration) and an actual block configuration supported by a use case (e.g., a particular block configuration). At operation 1040, the one or more processors can utilize the determined scaling ratio and offsets to convert the block indices of the determined block configuration (e.g., the fixed block configuration) to block indices of the use case block configuration (e.g., the particular block configuration).

FIG. 11 shows an illustrative example of a lookup table (LUT) including various different voxel block configurations with different corresponding hardware cache size requirements. The lookup table may be referred to (e.g., by the one or more processors) for choosing a fixed block configuration for operation of the algorithm 900 of FIG. 9. In particular, FIG. 11 is a table 1100 illustrating examples of different voxel block configurations with corresponding hardware cache requirements. In FIG. 11, the table is shown to include a plurality of columns, which include a sample distance 1110 column, a block size 1120 column, a number of voxel blocks 1130 column, and a hardware cache size requirement 1140 column.

The sample distance 1110 column of table 1100 of FIG. 11 shows different sample distances in meters (m). A sample distance is the distance (e.g., in meters) between two adjacent samples within the same voxel block. For example, as shown in FIG. 12, sample 1230a is an example of a sample within voxel block 1210a. Sample 1230b is an example of a sample within voxel block 1210b.

The block size 1120 column of table 1100 of FIG. 11 shows different block sizes for a voxel block. A block size is the number of voxels that a single voxel block contains. For example, as shown in FIG. 12, voxel block 1210a is a 4 by 4 by 4 block including a total of 8 voxels 1220a. As such, voxel block 1210a has a block size of 4. Voxel block 1210b of FIG. 12 is a 16 by 16 by 16 block including a total of 64 voxels 1220b. As such, voxel block 1210b has a block size of 16.

The number of voxels blocks 1130 column of table 1100 of FIG. 11 shows the number of voxel blocks (e.g., voxel block 1210a, 1210b of FIG. 12) used for a scene. For example, for block configuration 1150 (e.g., shown in the seventh row of the table 1100), a total of 1.5K voxel blocks are to be used for the scene. The hardware cache size requirement 1140 column of table 1100 of FIG. 11 shows the hardware cache size requirement (e.g., in bytes (B)) for the 3DR of the scene. For example, for the block configuration 1150, a hardware cache size of 19 kilobytes (KB) is required.

Each row in the table 1100 of FIG. 11 shows an example of a block configuration. For example, the seventh row in the table 1100 shows a block configuration 1150 that only requires a cache size of 19 KB. Since this block configuration 1150 has a low cache size requirement, this block configuration 1150 may be utilized as a fixed block configuration for the algorithm 900 of FIG. 9. For example, this block configuration 1150 may be utilized as a fixed block configuration when the algorithm 900 is utilizing any of the block configurations (e.g., particular block configurations, which may be actual use case block configurations) shown in the rows above the seventh row (e.g., any of the block configurations in the first six rows of table 1100).

FIG. 12 is a diagram 1200 that shows examples of different voxel blocks 1210a, 1210b as well as shows algorithm 900 of FIG. 9. In particular, FIG. 12 is a diagram illustrating an example of a scalable voxel block selection algorithm 900 that utilizes a fixed block configuration, where an example of a fixed block configuration (e.g., the configuration of voxel block 1210a) and an example of a particular block configuration (e.g., the configuration of voxel block 1210b) are illustrated.

In FIG. 12, two example voxel blocks 1210a, 1210b are shown. As mentioned, voxel block 1210a is a 4 by 4 by 4 block including a total of 8 voxels 1220a and, as such, voxel block 1210a has a block size of 4. Voxel block 1210b of FIG. 12 is a 16 by 16 by 16 block including a total of 64 voxels 1220b and, as such, voxel block 1210b has a block size of 16.

Each of the eight voxels 1220a of voxel block 1210a is shown to include a sample 1230a. As such, voxel block 1210a includes a total of 8 samples. Similarly, each of the 64 voxels 1220b of voxel block 1210b is shown to include a sample 1230b. As such, voxel block 1210b includes a total of 64 samples.

The voxel block 1210a (e.g., with a block size of 4) has a smaller block size than the voxel block 1210b (e.g., with a block size of 16). As such, the configuration of the voxel block 1210a may have a smaller cache size requirement than the configuration of the voxel block 1210b. Therefore, for the algorithm 900 of FIG. 9, the configuration of the voxel block 1210a may be used as the fixed block configuration, when the configuration of the voxel block 1210b is the particular block configuration being used (e.g., for a specific use case).

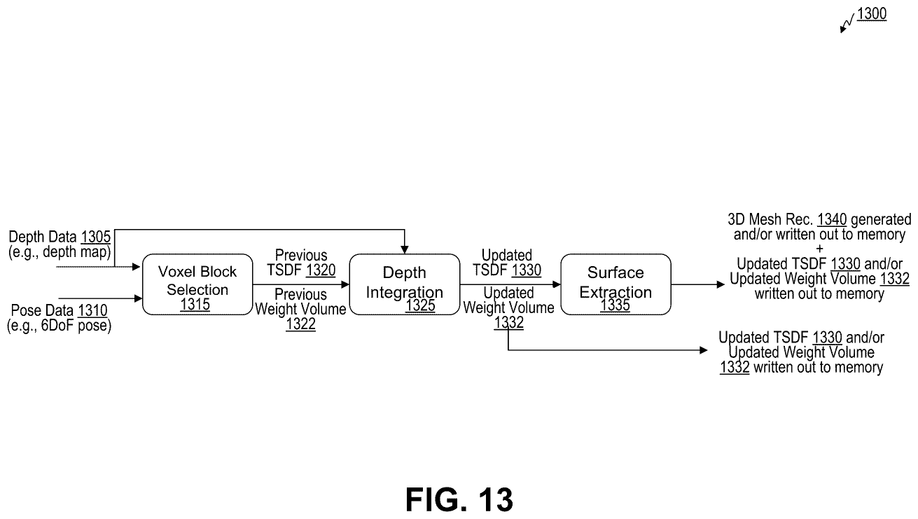

FIG. 13 is a flow diagram illustrating a process 1300 for generating a 3D mesh of a scene based on a depth map and a pose, in accordance with some examples. The process 1300 may be performed using a 3D reconstruction system. The 3D reconstruction system receives depth map 1305 of a scene, which may be an image that includes a respective depth value for each pixel of the image. The depth map 1305 may be considered two-dimensional (2D), given that the depth map 1305 may be a 2D plane of set of depth values arranged across a 2D plane. The depth map 1305 may be captured by a capture device, and may represent depth values from the perspective of the capture device and based on the pose 1310 (e.g., position and/or orientation) of the capture device. The 3D reconstruction system also receives the pose 1310 of the capture device (e.g., that captures the depth map 1305), which may include a position (e.g., longitude, latitude, altitude) and/or orientation (e.g., pitch, yaw, roll) of the capture device. In some examples, the capture device may be an XR device (e.g., a headset and/or head mounted display (HMD) device), a mobile handset, a phone, a wireless communication device, or a combination thereof. The pose 1310 may be a 6 degrees of freedom (6DoF) pose, a 3 degrees of freedom (6DoF) pose, or another type of pose, for instance depending on the types of pose sensor(s) (e.g., accelerometer(s), gyroscope(s), gyrometer(s), positioning receiver(s), inertial measurement unit(s), or combination(s) thereof) that the capture device includes

The 3D reconstruction system processes the depth map 1305 and the pose 1310 using voxel block selection 1315, depth integration 1325, and surface extraction 1335 to generate a 3D mesh of the scene. More specifically, the 3D reconstruction system processes the depth map 1305 and the pose 1310 using voxel block selection 1315 to identify which blocks of voxels (e.g., block 600 of 512 voxels) that make up the scene includes at least one depth pixel in the depth map 1305, with the origin and the direction of the depth values of the depth map 1305 being identified by the pose 1310. The voxel block selection 1315 selects the voxel blocks that include at least one depth pixel, and in some cases, that includes at least a threshold amount of depth pixels. In an illustrative example, the voxel block selection 1315 (by the 3D reconstruction system) may return the 10 indices to 10 different blocks.

The voxel block selection 1315 also identifies previous truncated signed distance function (TSDF) values 1320 for specific points in the depth map 1305 and/or in the selected voxel blocks (e.g., that were selected via the voxel block selection 1315). The TSDF value for a particular point denotes the distance of the particular point to the closest surface in the 3D mesh representation of the scene. For instance, if a point lies on a surface in the 3D mesh representation of the scene, the TSDF value for that point is zero. However, if a point lies a distance away from the nearest surface in the 3D mesh representation of the scene, the TSDF value for that point is non-zero. In some examples, a sign of a TSDF value (e.g., whether the TSDF value is positive or negative) can indicate which side of a surface the point is on. In some examples, if the point is on the outside of a surface (e.g., the outside of an object that the surface is a part of), then the TSDF value is positive, while if the point is on the inside of the surface (e.g., the inside of the object that the surface is a part of), then the TSDF value is negative. In some examples, the voxel block selection 1315 also identifies previous weight volume values 1322 for the points. A weight volume for a point is a counter that indicates how many times a given point was updated and/or changed (e.g., how many times a vertex of a particular surface of a particular polygon in a 3D mesh representation of a scene has been updated and/or changed over time).

In some examples, the voxel block selection 1315 specifically selects voxel blocks that are likely to include surfaces in the 3D mesh representation of the scene. In some examples, as noted above, to do this, the voxel block selection 1315 selects voxel blocks that include at least a threshold amount of points from the depth map 1305 (e.g., at least one point, or at least a threshold number of points where the threshold is greater than one). In some examples, the voxel block selection 1315 selects voxel blocks for which the previous TSDF values 1320 are within a threshold distance of zero, and/or for which the previous weight volume values 1322 are less than, equal to, or greater than a weight volume threshold.

The depth integration 1325 of the 3D reconstruction system receives, as its inputs, the depth map 1305, the voxel blocks selected by the voxel block selection 1315, the previous TSDF values 1320 identified by the voxel block selection 1315, the previous weight volume values 1322 identified by the voxel block selection 1315, and/or the pose 1310. As part of the depth integration 1325, the 3D reconstruction system summons the blocks for which the voxel block selection 1315 returned indices. The 3D reconstruction system updates and/or integrates the TSDF values for the points within those voxel blocks (e.g., points from the depth map 1305, and/or points corresponding to specific voxels within the voxel blocks). As part of the depth integration 1325, the 3D reconstruction system can thus generate updated TSDF values 1330 for the points, and/or updated weight volume values 1322 for the points. In some examples, during the depth integration 1325, the 3D reconstruction system can continue to keep track of the indices identified in the voxel block selection 1315.

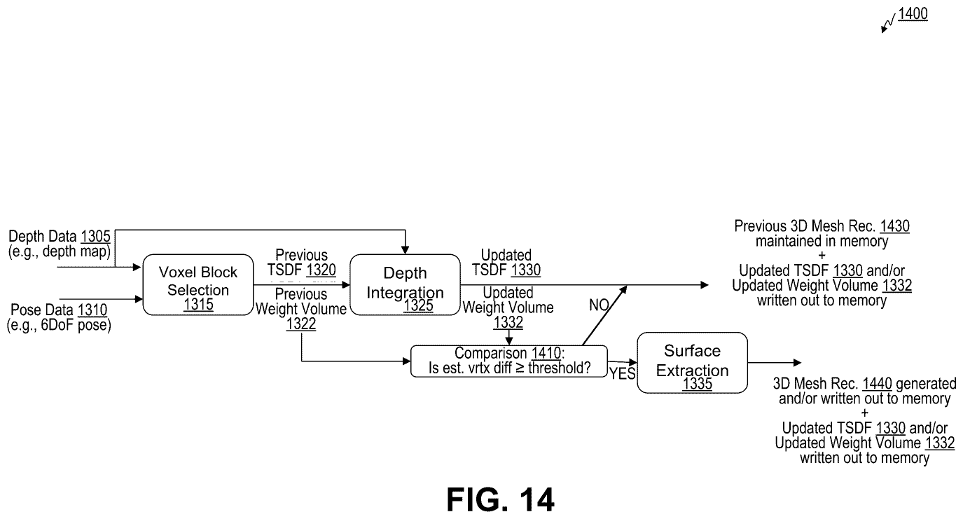

For the voxel blocks selected by the voxel block selection 1315 (e.g., for which the voxel block selection 1315 identified indices), the surface extraction 1335 extracts the surfaces of the 3D mesh representation 1340 of the scene, computes (generates) the 3D mesh representation 1340 of the scene, and/or writes out the 3D mesh representation 1340 of the scene (e.g., into memory). The surface extraction 1335 can identify the surfaces of the 3D mesh representation 1340 based on the updated TSDF values 1330 and/or the updated weight volume values 1322, for instance with the surfaces being arranged so that points having updated TSDF values 1330 of zero (or within a threshold distance of zero) fall on or near (e.g., within a threshold distance of) the surface. In some examples, the surface extraction 1335 uses a marching cube algorithm to extract the surfaces, generate the 3D mesh representation 1340, and/or write out the 3D mesh representation 1340. The process is repeated many times for all the voxel blocks that cover the camera view frustum, even if there is no change occurring in the scene. Notably, each time the surface extraction 1335 summons the blocks, extracts the surfaces, generates the 3D mesh representation 1340, and/or writes out the 3D mesh representation 1340, the surface extraction 1335 uses up a significant amount of memory, bandwidth, storage space, and/or computational resources (e.g., CPU and/or GPU resources). High usage of these computational resources can also increased heat generation and/or increase need for heat dissipation components (e.g., heat sinks, fans, coolant-based coolers and/or other cooling mechanisms). Thus, without any adaptive mechanism as in the process 1400 illustrated in FIG. 14, the process 1300 can waste resources on surface extraction 1335 (e.g., on extracting the surfaces, generating the 3D mesh representation 1340, and/or writing out the 3D mesh representation 1340) even if little or nothing has changed.

In some examples, the 3D reconstruction system can also write out the updated TSDF values 1330 and/or the updated weight volume values 1332 to memory.

FIG. 14 is a flow diagram illustrating a process 1400 for determining whether to generate a new 3D mesh of a scene based on whether a significant change is detected between a truncated signed distance function (TSDF) value and a previous TSDF value, in accordance with some examples. The process 1400 may be performed using a 3D reconstruction system. Like the process 1300, the process 1400 includes voxel block selectin 1315, depth integration 1325, and surface extraction 1335.

However, the process 1400 adds an adaptive decisioning controller that controls whether or not the surface extraction 1335 is performed at a given time. In a first pass, where no 3D mesh reconstruction has been created of the scene yet, the 3D reconstruction system can perform surface extraction 1335 to extract the surfaces, generate the 3D mesh reconstruction 1440, and/or write out the 3D mesh reconstruction 1440, similarly to the process 1300. However, once a 3D mesh reconstruction of the scene exists, then at subsequent passes, the 3D reconstruction system can run a comparison 1410 to identify whether the topology of the 3D mesh reconstruction of the scene (e.g., the vertex(es) of the surface(s) of the mesh) is likely to change more than a threshold amount or not. In some examples, the comparison 1410 specifically compares an estimated vertex difference (e.g., estimated vertex difference 1740) to the threshold amount. If the comparison 1410 indicates that the 3D mesh reconstruction of the scene (e.g., the estimated vertex difference, or another indication of change(s) to the vertex(es) of the surface(s) of the mesh) does not change at all, or changes by an amount that is less than or equal to the threshold, then the process 1400 bypasses the surface extraction 1335, and the previous 3D mesh reconstruction 1430 of the scene (e.g., corresponding to the previous TSDF values 1320, previous weight volume values 1322, previous depth map, and/or previous pose) is maintained in memory as the current 3D mesh representation of the scene.

If the comparison 1410 indicates that the 3D mesh reconstruction of the scene (e.g., the vertex difference, or another indication of change(s) to the vertex(es) of the surface(s) of the mesh) changes by an amount that is greater than or equal to the threshold, then the process 1400 performs the surface extraction 1335 as in the process 1300, by extracting the surfaces, generating an updated 3D mesh reconstruction 1440, and/or writing out the updated 3D mesh reconstruction 1440 to memory. In some examples, 3D reconstruction system can also write out the updated TSDF values 1330 and/or the updated weight volume values 1332 to memory.

In some examples, to generate the estimated vertex difference for the comparison 1410, the 3D reconstruction system compares the updated TSDF values 1330 and/or the updated weight volume values 1332 (e.g., generated via the depth integration 1325) to the previous TSDF values 1320 and/or the previous weight volume values 1322 (e.g., identified via the voxel block selection 1315). By allowing the 3D reconstruction system to bypass surface extraction 1335 whenever the comparison 1410 indicates that 3D mesh representation is unlikely to change by more than the threshold, the process 1400 can reduce usage of memory, bandwidth, storage space, and/or computational resources (e.g., CPU and/or GPU resources) compared to the process 1300. Reducing usage of these computational resources in the process 1400 can also decrease heat generation and/or decrease need for heat dissipation components (e.g., heat sinks, fans, coolant-based coolers and/or other cooling mechanisms) compared to the process 1300.

In some examples, the estimated vertex difference for the comparison 1410 is generated using one or more trained machine learning model(s). In some examples, the 3D reconstruction system inputs and/or processes the previous TSDF values 1320, updated TSDF values 1330, the previous weight volume values 1322, and/or the updated weight volume values 1332 into the trained machine learning model(s) to generate the estimated vertex difference for the comparison 1410.

In some examples, the estimated vertex difference for the comparison 1410 is generated using one or more linear regression model(s). In some examples, the 3D reconstruction system processes the previous TSDF values 1320, updated TSDF values 1330, the previous weight volume values 1322, and/or the updated weight volume values 1332 using the linear regression model(s) to generate the estimated vertex difference for the comparison 1410.

In some examples, the 3D reconstruction system can include a post-processing engine that applies post-processing operation(s) to extracted mesh (e.g., to the 3D mesh reconstruction 1440 generated by the surface extraction 1335). For instance, the post-processing operation(s) can include mesh simplification, for instance to reduce a triangle count and/or polygon count. The process 1400 can be used as described even in a 3D reconstruction system that includes such a post-processing engine and/or applies such post-processing operation(s). For instance, in some examples, the trained machine learning model(s) that the 3D reconstruction system uses to generate the estimated vertex difference for the comparison 1410 can be trained to account for post-processing operation(s), for instance if the post-processing operation(s) are applied in a consistent way and/or have a consistent functionality.

In some examples, the trained machine learning model(s) that generate the estimated vertex difference for the comparison 1410 can map the difference in the TSDF domain (e.g., the difference between the updated TSDF values 1330 and the previous TSDF values 1320) to the difference in the mesh domain (e.g., a predicted difference between the 3D mesh reconstruction 1440 of the scene and a previous 3D mesh representation of the scene). In some examples, the trained machine learning model(s) (e.g., neural network(s)) can be trained to identify a non-linear mapping between the TSDF domain and the mesh domain. In some examples, the mapping can operate on the direct difference of TSDF values (e.g., the difference between the updated TSDF values 1330 and the previous TSDF values 1320) with some linear scaling to estimate the mesh domain difference, according to the equation below:

$$d = ( α ( {t}_{1} - {t}_{2} ) + β )$$

In the equation above, d refers to a difference in the mesh domain (e.g., the estimated vertex difference), t₁ refers to the previous TSDF value 1320 (e.g., pre-update TSDF value), t₂ refers to the updated TSDF value 1330 (e.g., post-update TSDF value), and alpha (α) and beta (β) are parameters that can be adjusted based on the linear regression model(s) and/or based on the training of the machine learning model(s). For instance, alpha (α) can refer to a scaling factor, and beta (β) can refer to an offset. In some examples, more complex (e.g., non-linear) mapping functions between the mesh domain and the TSDF domain may be more accurate but use more computational resources, while less complex (e.g., linear) mapping functions between the mesh domain and the TSDF domain may be less accurate in some situations but are more efficient (e.g., use fewer computational resources).

In some examples, 3D mesh reconstruction of a scene is performed on portable devices, such as an XR device (e.g., a headset and/or head mounted display (HMD) device), a mobile handset, a phone, a wireless communication device, or a combination thereof. To be portable, such devices are generally small, and therefore have limited battery capacity, limited memory, limited bandwidth, and limited computational resources available. Thus, use of the process 1400 makes 3D mesh reconstruction of a scene more usable for portable devices than the process 1300, as the process 1400 can help reduce usage of computational resources, memory, bandwidth, and battery draw, and thus save battery life and preserve computational resources, memory, bandwidth. Keeping device temperature below certain threshold levels is also important for portable devices, especially for wearable devices, to avoid burning the user or providing discomfort to the user. The process 1400 can also help such devices reduce heat generation relative to the process 1300 by periodically skipping computationally-intensive surface extraction 1335 process that might otherwise cause the device to generate heat. High levels of heat can also reduce performance of certain device components, so the process 1400 can improve overall performance of the device by keeping heat low, relative to the process 1300. Heat dissipation components (e.g., heat sinks, fans, coolant-based coolers and/or other cooling mechanisms) can be large. For instance, even passive heat sinks work by increasing surface area that is in contact with air or another cooling medium. Thus, the process 1400 can reduce the size of a device by reducing need for heat dissipation components, relative to the process 1300. Some heat dissipation components, such as fans or coolant-based coolers, can require power to function and therefore increase power draw. Thus, the process 1400 can reduce a device's power draw further by reducing need for heat dissipation components, relative to the process 1300.

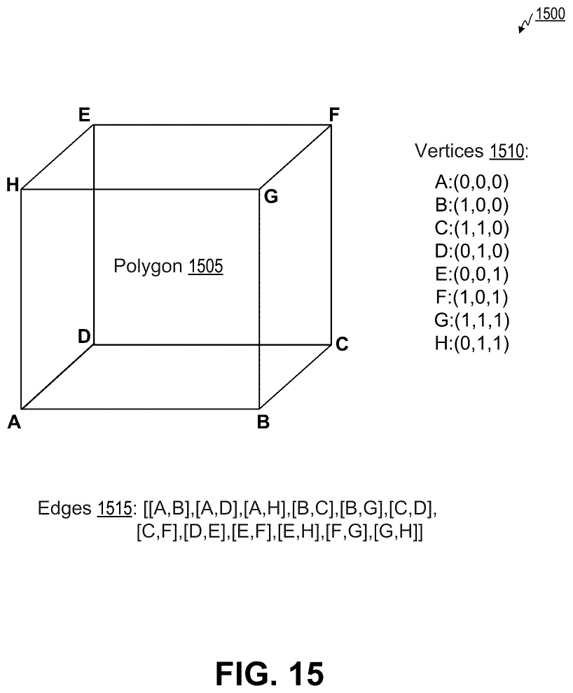

FIG. 15 is a conceptual diagram 1500 illustrating representations of the vertices 1510 and edges 1515 of a polygon 1505 (e.g., a cube), in accordance with some examples. The eight vertices 1510 of the polygon 1505 (e.g., the cube) are identified as A, B, C, D, E, F, G, and H. The eight vertices 1510 of the polygon 1505 (e.g., the cube) are represented using three-dimension coordinates as A:(0,0,0); B:(1,0,0); C:(1,1,0); D:(0,1,0); E:(0,0,1); F:(1,0,1); G:(1,1,1); and H:(0,1,1). The twelve edges 1515 of the polygon are represented using pairs of vertices as [A, B]; [A, D]; [A, H]; [B, C]; [B, G]; [C, D]; [C, F]; [D, E]; [E, F]; [E, H]; [F, G]; and [G, H].

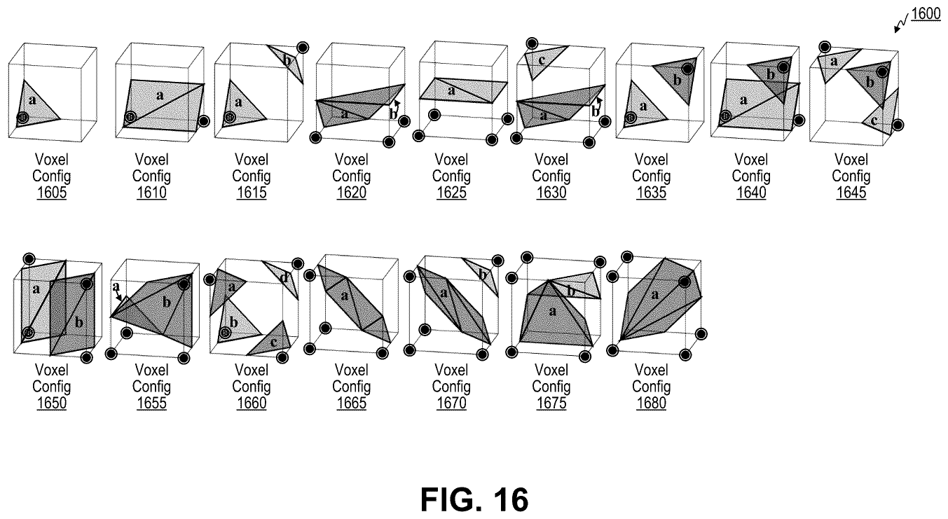

FIG. 16 is a conceptual diagram 1600 illustrating representations of surface extraction and mesh generation (e.g., using the surface extraction 1335) at a voxel level, in accordance with some examples. Using the marching cube algorithm, surface extraction 1335 is performed one voxel at a time. Each voxel is a cube having eight corners. The eight vertices 1510 of the polygon 1505 (e.g., cube) A, B, C, D, E, F, G, and H of FIG. 15 are examples of the eight corners of a voxel. Each of the eight corners is a point having its own TSDF value. The TSDF value for a point may be positive, negative, or zero. Based on whether the TSDF values for the corners of the voxel are positive, negative, or zero, the corresponding surface(s) that best fit that particular voxel may change. Assuming the TSDF value for each corner is either positive or negative, a given voxel can have 28-256 different surface configurations.

If all of the corners of the voxel have positive TSDF values, this indicates that the entirety of the voxel is outside of the surface, so no surface intersects with that voxel. Similarly, all of the corners of the voxel have negative TSDF values, this indicates that the entirety of the voxel is inside of the surface, so again, no surface intersects with that voxel. Thus, those two voxel configurations represent voxels with no surfaces in them. This leaves 256−2=254 configurations of voxels for which a surface intersects with the voxel. Depending on which corners are positive or negative, these 254 voxel configurations can be represented by 16 different voxel configurations, including voxel configuration 1605, voxel configuration 1610, voxel configuration 1615, voxel configuration 1620, voxel configuration 1625, voxel configuration 1630, voxel configuration 1635, voxel configuration 1640, voxel configuration 1645, voxel configuration 1650, voxel configuration 1655, voxel configuration 1660, voxel configuration 1665, voxel configuration 1670, voxel configuration 1675, and the voxel configuration 1680.

These 16 different voxel configurations may be rotated depending on which corners have positive TSDF values vs. which corners have negative TSDF values. The surface extraction 1335 computes the zero crossings along the edges of the voxels based on the TSDF values of the corners. For instance, if a first corner have a positive TSDF value and a second corner has a negative TSDF value, then a zero crossing of the surface (e.g., the point at which the TSDF value is zero) occurs somewhere along the edge of the voxel between the first corner and the second corner. The zero crossing can be estimated differently depending on the respective magnitudes (e.g., absolute values) of the TSDF values of the two corners, for instance so that the zero crossing is closer to whichever corner has the lower magnitude (e.g., absolute value) of its TSDF value. The zero crossing location along the edge of the voxel indicates where a given surface intersects with the voxel.

The voxel configurations 1605-1680 are illustrated in FIG. 16 with certain corners of the voxel being represented by large dark dots with circles around them (referred to as “circled dots” below), and other corners lacking the circled dots. The dots (within the circled dots) are illustrated as black where unoccluded by surfaces, or shaded with a halftone pattern where occluded by surfaces. The corners represented by the large circled dots have TSDF values with a different sign than the TSDF values of the corners that lack the circled dots. For instance, in a first illustrative example, the corners illustrated with circled dots have negative TSDF values, while the corners that lack the circled dots have positive TSDF values. In a second illustrative example, the corners illustrated with circled dots have positive TSDF values, while the corners that lack the circled dots have negative TSDF values. The surface(s) that intersect with a given voxel are illustrated as translucent grey surfaces, with each surface made up of one or more triangles. In situations where a voxel has two or more intersecting surfaces that are close to one another and/or overlap from the perspective illustrated in FIG. 16, the surfaces intersecting the voxel (and that are close to one another) are shaded using two different shades of grey (one lighter and one darker) to help distinguish the different surfaces. Furthermore, the surfaces intersecting the voxel are labeled with letters (e.g., a, b, c, d, and so forth). Voxels with only one intersecting surface are illustrated with that surface labeled “a”; voxels with two intersecting surfaces are illustrated with those surface labeled “a” and “b,” respectively; voxels with three intersecting surfaces are illustrated with those surface labeled “a,” “b,” and “c” respectively; and so forth. In some examples, a given voxel configuration can look the same if the respective TSDF values of all of the corners flip signs. For instance, the position of the surface intersecting the voxel configuration 1605 can be the same regardless of whether (a) the corner with the circled dot has a negative TSDF value and the other corners without the circled dots have positive TSDF values, or (b) the corner with the circled dot has a positive TSDF value and the other corners without the circled dots have negative TSDF values.

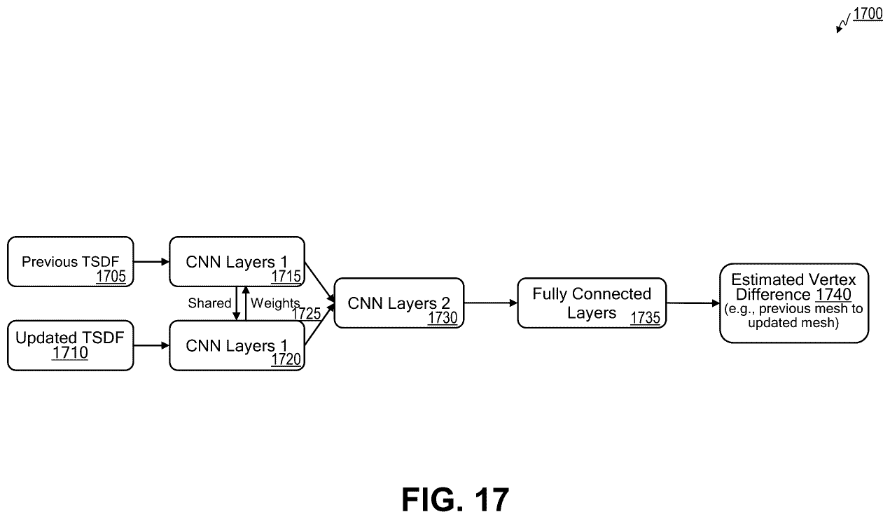

FIG. 17 is a block diagram illustrating a neural network architecture 1700 for comparing updated truncated signed distance function (TSDF) values 1710 and previous TSDF values 1705 to identify a estimated vertex difference 1740, in accordance with some examples. For each voxel, surface extraction 1335 identifies zero crossings on a specific edge of the voxel by identifying that the corners of the voxel that are the endpoints of that edge have respective TSDF values with different signs (e.g., one corner has a positive TSDF value and the other corner has a negative TSDF value). Each voxel can be represented as a list of twelve edges 1515.

The previous TSDF values 1705 and the updated TSDF value 1710 are input into the neural network architecture 1700. In some examples, the previous TSDF values 1705 and the updated TSDF value 1710 are input into the neural network architecture 1700 as a list of corners or vertices per voxel (e.g., as in the vertices 1510) with corresponding TSDF values, as a list of edges per voxel (e.g., as in the edges 1515) with corresponding pairs of TSDF values, or a combination thereof. The previous TSDF values 1705 are examples of the previous TSDF values 1320, or vice versa. The updated TSDF values 1710 are examples of the updated TSDF values 1330, or vice versa. The previous TSDF values 1705 can be referred to as pre-integration TSDF values. The updated TSDF values 1710 can be referred to as post-integration TSDF values.

The neural network architecture 1700 includes a number of convolutional neural network (CNN) layers and a set of fully connected (FC) layers 1735 that process the previous TSDF values 1705 and the updated TSDF value 1710 to identify a estimated vertex difference 1740. The determination of the estimated vertex difference 1740 by the neural network architecture 1700 can allow a 3D reconstruction system to avoid the computationally-expensive process of computing a new mesh, fetching the previously computed mesh into cache, and/or computing associated distance(s) explicitly (e.g., measuring the distance of each vertex in the new mesh from its nearest neighbor in the previous mesh) as in the surface extraction 1335. Instead, by processing the previous TSDF values 1705 and the updated TSDF value 1710 to identify the estimated vertex difference 1740, the neural network architecture 1700 maps differences in the TSDF domain to distances in the mesh domain. In some examples, the estimated vertex difference 1740 is determined as part of the comparison 1410 in the process 1400. In some examples, the neural network architecture 1700 is an example of a feed-forward network. The estimated vertex difference 1840 may be an example of the estimated vertex difference for the comparison 1410, or vice versa.

In some examples, the first set of CNN layers (e.g., CNN Layers 1 1715 and CNN Layers 1 1720) are one-dimensional filters with kernel size one, and can be shared among the two branches (e.g., a branch that processes the previous TSDF value 1705 and the updated TSDF value 1710) of the neural network architecture 1700. In some examples, the first set of CNN layers (e.g., CNN Layers 1 1715 and CNN Layers 1 1720) are trained to simulate or estimate or predict results that would be expected from the marching cube algorithm, for instance including classification of different voxels of the scene into one of the voxel configurations 1605-1680 of FIG. 16, or as “blank” voxels with no intersecting surfaces. In some examples, because the previous TSDF values 1705 and the updated TSDF value 1710 share a format, and the first set of CNN layers (e.g., CNN Layers 1 1715 and CNN Layers 1 1720) perform the same or similar operations, the neural network architecture 1700 includes shared weights 1725 between the first set of CNN layers (e.g., CNN Layers 1 1715 and CNN Layers 1 1720) and/or between the inputs. In some examples, the CNN Layers 1 1715 and CNN Layers 1 1720 are a single layer or set of layers that processes both the previous TSDF value 1705 and the updated TSDF value 1710. In some examples, the CNN Layers 1 1715 and CNN Layers 1 1720 are separate layers or sets of layers, with the CNN Layers 1 1715 processing the previous TSDF value 1705 and the CNN Layers 1 1720 processing the updated TSDF value 1710.

The neural network architecture 1700 passes the outputs of the first set of CNN layers (e.g., CNN Layers 1 1715 and CNN Layers 1 1720) to a second set of CNN layers (e.g., the CNN Layers 2 1730). The neural network architecture 1700 passes the outputs of the second set of CNN layers (e.g., the CNN Layers 2 1730) to the fully connected (FC) layers 1735. The fully connected (FC) layers 1735 output the estimated vertex difference 1740, which represents an estimated or predicted difference in the mesh domain between the scene based on previous data (e.g., previous depth map, previous pose, and/or previous TSDF values 1705) and the scene based on updated data (e.g., updated depth map, updated pose, and/or updated TSDF values 1710). The second set of CNN layers (e.g., the CNN Layers 2 1730) and the fully connected (FC) layers 1735 can map the difference in the TSDF domain to the estimated vertex difference 1740 in the mesh domain.

The estimated vertex difference 1740 may represent one of a set of possible types of metrics for measuring differences in the mesh domain. One type of metric is cloud-to-cloud difference, in which distance is measured between a point from a previous mesh (or an associated point cloud) to the nearest point in the updated mesh (or associated point cloud), and so on for each point in the two meshes. The finding of the nearest point in one mesh to a point in another mesh can be referred to as a nearest-neighbor search. In situations where the previous mesh is identical to the updated mesh, the cloud-to-cloud difference indicates no changes. In situations where the updated mesh is different than the previous mesh, the cloud-to-cloud difference indicates changes wherever there are differences in locations of points between the updated mesh and the previous mesh. The term cloud, in this context, can refer to point cloud(s) associated with the mesh(es) (e.g., the previous mesh and/or the updated mesh). Another type of metric is cloud-to-mesh difference, in which distance is measured from vertices in one mesh to the closest surface or plane in the other mesh, and so on for each vertex in the two meshes. If the two meshes are identical, then each vertex falls on the other mesh's surface(s) or plane(s), and therefore the cloud-to-mesh difference is zero. Otherwise, the cloud-to-mesh difference is non-zero. Another type of metric is mesh-to-mesh difference, in which distance is measured between a vertex from a previous mesh to the corresponding vertex in the updated mesh, and so on for each vertex in the two meshes. If the two meshes are identical, then each vertex falls on a corresponding vertex in the other mesh, and therefore the mesh-to-mesh difference is zero. Otherwise, the mesh-to-mesh difference is non-zero.

The neural network architecture 1700 may be trained using training data. The training data may include previous TSDF values (e.g., as in the previous TSDF values 1705 and/or the previous TSDF values 1320), corresponding updated TSDF values (e.g., as in the updated TSDF values 1710 and/or the updated TSDF values 1330), and an actual vertex difference (e.g., as in the estimated vertex difference 1740 and/or the estimated vertex difference 1840) computed based on the actual previous mesh (e.g., previous 3D mesh reconstruction 1430 of the scene) and an actual updated mesh generated using surface extraction 1335 (e.g., 3D mesh representation 1340 of the scene, 3D mesh reconstruction 1440 of the scene). In some examples, in situations where a 3D reconstruction system actually performs surface extraction 1335 to generate an updated mesh (e.g., where the comparison 1410 indicates that the estimated vertex difference 1740 is greater than or equal to the threshold, and the 3D reconstruction system thus generates the 3D mesh reconstruction 1440 via the surface extraction 1335), the neural network architecture 1700 can be updated, further trained, and/or re-trained, using the actual vertex difference between the updated mesh and the previous mesh as training data.

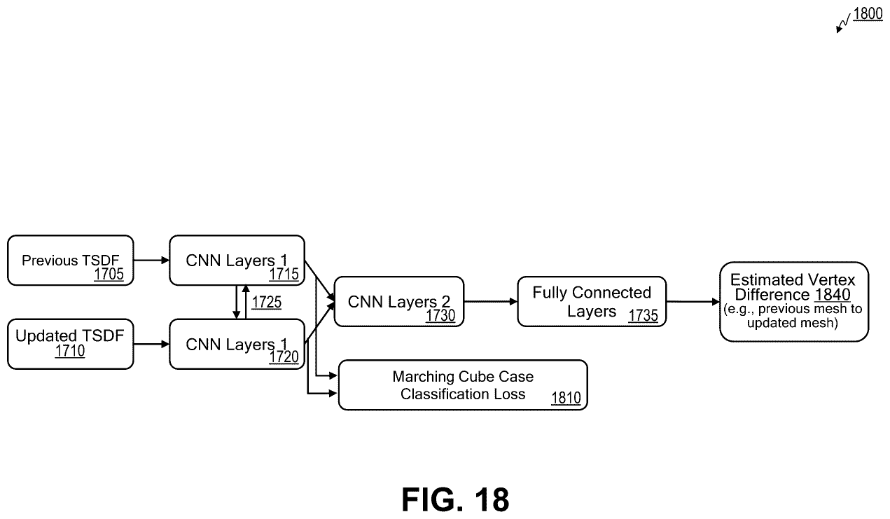

FIG. 18 is a block diagram illustrating a neural network architecture 1800 for comparing the updated truncated signed distance function (TSDF) values 1710 and the previous TSDF values 1705 to identify the estimated vertex difference 1840, with the neural network architecture 1800 including a marching cube case classification loss function 1810. Like the neural network architecture 1700, the neural network architecture 1800 receives the previous TSDF values 1705 and the updated TSDF values 1710 as inputs. Like the neural network architecture 1700, the neural network architecture 1800 processes the previous TSDF values 1705 and the updated TSDF values 1710 using the first set of CNN layers (e.g., CNN Layers 1 1715 and CNN Layers 1 1720), the second set of CNN layers (e.g., the CNN Layers 2 1730), and/or the fully connected (FC) layers 1735 to generate the estimated vertex difference 1840. The estimated vertex difference 1840 may be an example of the estimated vertex difference 1740 and/or the estimated vertex difference for the comparison 1410, or vice versa. Like the neural network architecture 1700, the neural network architecture 1800 may include shared weights 1725 between the first set of CNN layers (e.g., CNN Layers 1 1715 and CNN Layers 1 1720) and/or between the previous TSDF values 1705 and the updated TSDF values 1710.

The neural network architecture 1700 and the neural network architecture 1800 may be trained based on actual vertex differences calculated between previous meshes and corresponding updated meshes. In some examples, a vertex difference between two computed meshes may be calculated using the equation below:

$${d}^{*} = {\sum }_{v ∈ {m}_{2}} {\vert v - n ( v ) \vert}_{2} , n ( v ) = {min}_{{v}^{′} ∈ {m}_{1}} {\vert v - {v}^{′} \vert}_{2}$$

The equation above calculates the vertex difference d′ between two computed meshes based on a cloud-to-cloud distance metric. In some examples, a vertex difference d* between two computed meshes may be calculated using the equation below, which is based on a cloud-to-mesh distance metric:

$${d}^{*} = {\sum }_{v ∈ {m}_{2}} d ( v ) , d ( v ) = {min}_{{t}^{′} ∈ {m}_{1}} {\vert v - P ( v \vert {t}^{′} ) \vert}_{2}$$

In the equations above, d′ refers to the vertex difference (or distance) between the two respective meshes m₁, m₂. In the equations above, v refers to a vertex in a mesh and P(v|t′) is the projection of vertex v onto the triangle t′

In some examples, the output features of the first set of CNN layers (e.g., CNN Layers 1 1715 and CNN Layers 1 1720) for the two TSDF volumes (e.g., for the previous TSDF values 1705 and the updated TSDF values 1710) are (by the neural network architecture 1700 and/or the neural network architecture 1800) concatenated and passed through second set of CNN layers (e.g., the CNN Layers 2 1730) with one-dimensional filters and kernel size one. The neural network architecture 1700 and/or the neural network architecture 1800 maps the output(s) of the second set of CNN layers (e.g., the CNN Layers 2 1730) to \hat{d}, for instance using the fully connected (FC) layers 1735. The value \hat{d} estimates d* (the distance between the two respective meshes) via a multi-layer perceptron. The value \hat{d} can represent the estimated vertex difference 1740 that is estimated using the neural network architecture 1700, the estimated vertex difference 1840 that is estimated using the neural network architecture 1800, and/or the estimated vertex difference for the comparison 1410.

In some examples, the neural network architecture 1800 applies a classification supervision at the output of the first set of CNN layers (e.g., CNN Layers 1 1715 and CNN Layers 1 1720) so that the output features can be mapped to one of the possible Marching Cube cases (e.g., the voxel configurations 1605-1680 that represent different triangle topologies) during the training stage. In some examples, comparison to the marching cube configurations can be performed using the marching cube case classification loss function 1810 to regulate the training of the neural network.

In some examples, the neural network architecture 1700 and/or the neural network architecture 1800 can be trained to simulate performance of two operations—the marching cube algorithm (for surface extraction 1335 to generate an updated mesh) and the nearest neighbor search (for identifying points in the updated mesh that are nearest to corresponding points in the previous mesh). In some examples, the first set of CNN layers (e.g., CNN Layers 1 1715 and CNN Layers 1 1720) are trained to simulate the marching cube algorithm (for surface extraction 1335). The marching cube case classification loss function 1810 can identify whether the first set of CNN layers identified the correct voxel configuration (e.g., of the voxel configurations 1605-1680) given the set of TSDF values (e.g., previous TSDF values 1705, updated TSDF values 1710) for a given voxel. In some examples, the later layers (e.g., the CNN Layers 2 1730 and/or the fully connected (FC) layers 1735) are trained to simulate the nearest neighbor search and computation of the distance between the corresponding points in the two meshes identified by the nearest neighbor search, to identify the vertex difference (also referred to as vertex distance) for the vertices in the voxel. In some examples, the later layers (e.g., the CNN Layers 2 1730 and/or the fully connected (FC) layers 1735) are trained to sum together the vertex differences for each of the vertexes in a given voxel, and/or for each of the voxels in a given voxel block, to generate the estimated vertex difference 1740 and/or the estimated vertex difference 1840 and/or the estimated vertex difference for the comparison 1410.

In some examples, a vertex difference loss function can include, or refer to, a loss function £ that can be used to compare the vertex difference estimates d (e.g., estimated vertex difference 1740, estimated vertex difference 1840, and/or estimated vertex difference for the comparison 1410) to computed actual vertex difference d* (as a ground truth computed using surface extraction 1335, for instance using the marching cube algorithm), based on the L1 loss equation below:

$$ℒ = {\vert \hat{d} - {d}^{*} \vert}_{1}$$

In some examples, the neural network architecture 1700 and/or the neural network architecture 1800 can be used to estimate the estimated vertex difference 1740 and/or the estimated vertex difference 1840 on a per-voxel level. In some examples, in the process 1400, the decision as to whether to perform surface extraction 1335 or not (based on whether the comparison 1410 of the estimated vertex difference is greater than the threshold) can be performed at the voxel block level. Thus, in some examples, the estimates of the estimated vertex difference 1740 and/or the estimated vertex difference 1840 that are computed on a per-voxel level using the neural network architecture 1700 and/or the neural network architecture 1800 can be added or averaged together for all of the voxels in the block, and the comparison 1410 of the estimated voxel difference to the threshold can be performed using the sum or average of the estimated vertex difference 1740 and/or the estimated vertex difference 1840 for each of the voxels in the block.

In some examples, to generate training data to train the neural network architecture 1700 and/or the neural network architecture 1800, a training system can randomly generate and/or sample values for the previous TSDF values 1705 (t₁) from the range [−1, 1] for each of the corners in a voxel cube. To simulate both slow and fast changes of TSDF values, the training system can generate values for the updated TSDF values 1710 (t₂) by adding an independent gaussian noise (n) with various strength σ to any of the corners in the voxel corresponding to the previous TSDF values 1705 (t₁) based on the equation below:

$${t}_{2} = {t}_{1} + σ \cdot n , n ∼ N ( 0 , 1 )$$

To understand how strong the added noise (n) should be, the training system can evaluate the variation in the TSDF values in a real-world scan of the scene (e.g., using ScanNet), and base the value of the strength σ on the distribution of TSDF value changes in the real-world scan of the scene. The strength σ indicates how slowly, or quickly, a given TSDF value is to change between the previous TSDF values 1705 and the updated TSDF values 1710 in the training set. Similarly, the strength σ can indicates how slowly, or quickly, a given point (vertex) in the mesh of the scene changes location from the previous mesh of the scene to the updated mesh of the scene.

In some examples, the neural network architectures discussed herein (e.g., neural network architecture 1700, neural network architecture 1800, neural network 2300) process the TSDF values (e.g., previous TSDF value 1320, updated TSDF value 1330, previous TSDF value 1705, updated TSDF value 1710) a voxel at a time to determine the estimated vertex difference (e.g., estimated vertex difference 1740, estimated vertex difference 1840) in the mesh domain as part of the comparison 1410. In some examples, the neural network architectures discussed herein process the TSDF values a voxel block (e.g., voxel block 600 of voxels) at a time to determine the estimated vertex difference in the mesh domain as part of the comparison 1410. In some examples, to determine the estimated vertex difference in the mesh domain, the TSDF values for one voxel block (and/or voxel) are subtracted from the TSDF values for another voxel block (and/or voxel) to identify a TSDF difference in the TSDF domain. Since the voxel blocks cover a larger volume than a single voxel, in some cases, the system(s) and process(es) described herein are optimized to focus on the parts within a voxel block that include surfaces (surface-including voxels), and/or that are closer to surfaces (e.g., are within a threshold distance of a surface) (near-surface voxels). To focus on these parts within voxel blocks, the system(s) and process(es) can use new TSDF values to identify surface-including voxels and/or near-surface voxels and consider the estimated vertex difference for those voxels, in some cases omitting voxels that are not near-surface voxels or surface-including voxels. In some examples, the system(s) and process(es) use the alpha and beta parameters for the linear regression to the map the TSDF difference to the estimated vertex difference in the mesh domain.

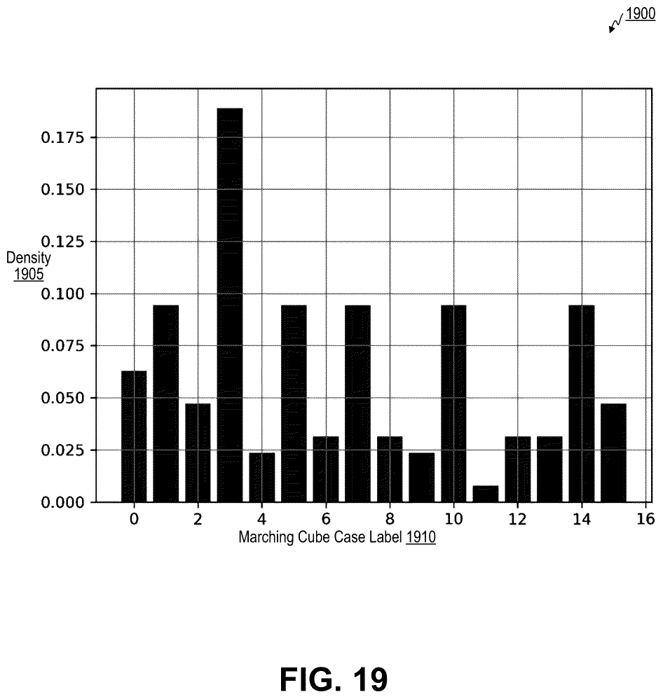

FIG. 19 is a graph diagram illustrating a histogram 1900 of density 1905 against marching cube case label 1910, in accordance with some examples. The horizontal axis of the histogram 1900 represents marching cube case label 1910 numbered from zero to 16. The values from zero to 15 along the marching cube case label 1910 axis represent the voxel configurations 1605-1680. For instance, in an illustrative example, zero on the marching cube case label 1910 axis represents the voxel configuration 1605, one on the marching cube case label 1910 axis represents the voxel configuration 1610, two on the marching cube case label 1910 axis represents the voxel configuration 1615, and so forth, with fifteen on the marching cube case label 1910 axis ultimately representing the voxel configuration 1680. The density 1905 along the vertical axis of the histogram 1900 indicates how common voxels with a given configuration (of the voxel configurations 1605-1680 as indicated by marching cube case label 1910) are in a 3D mesh reconstruction of a given scene. For the scene represented by the histogram 1900, the voxel configuration with label number three (voxel configuration 1620) is the most common (has the highest density 1905), while the voxel configuration with label number eleven (voxel configuration 1655) is the least common.

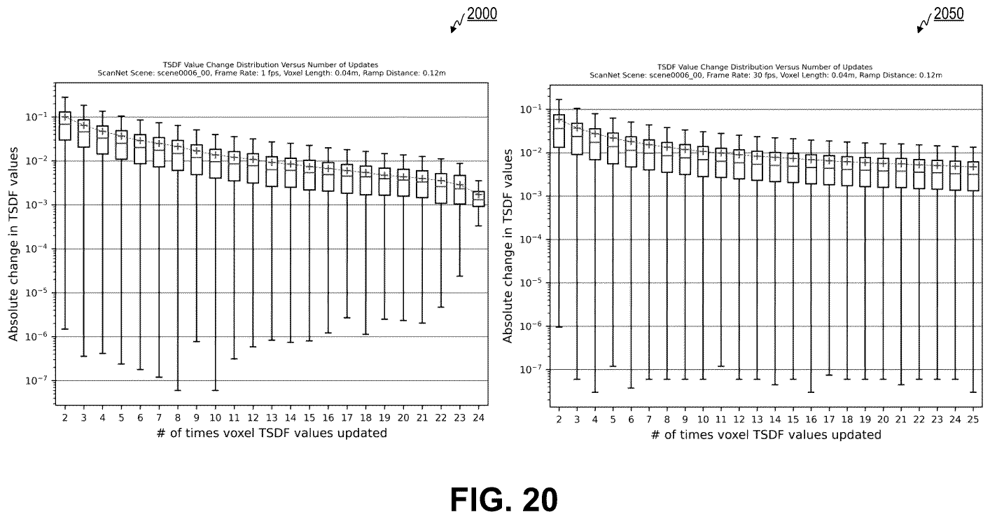

FIG. 20 is a graph diagram illustrating graphs (e.g., graph 2000 and graph 2050) of absolute changes in truncated signed distance function (TSDF) value relative to number of times voxel TSDF values are updated, in accordance with some examples. The horizontal axes for the graph 2000 and the graph 2050 indicate the number of times voxel TSDF values are updated. The vertical axes for the graph 2000 and the graph 2050 indicate absolute changes in TSDF value. The graph 2000 and the graph 2050 are both generated using the same scene, the same voxel length (0.04 m), and the same ramp distance (0.12 m). However, the graph 2000 uses a frame rate of 1 frame per second (fps), while the graph 2050 uses a frame rate of 30 fps. These two frame rates can be considered extremes, as 3D reconstruction systems can operate at frame rates higher than 1 fps and lower than 30 fps.

The graph 2000 and the graph 2050 show that, for both frame rates graphed in FIG. 20 (1 fps and 30 fps), the largest absolute change in TSDF happens when a voxel's TSDF is only updated twice. As the number of updates to the voxel's TSDF values is increased, the degree of change in the TSDF values reduces exponentially. In other words, the graph 2000 and the graph 2050 show that, as a 3D reconstruction system integrates more (e.g., performs depth integration 1325 more) and receives more samples over time, the TSDF values become more stable over time. The degree of change is higher for lower frame rates, as visible in the higher degree of change (along the vertical axis) in the graph 2000 compared to the graph 2050. This is expected, as reducing the number of frames per second can make movements appear less smooth, reducing the chances of gradual changes. The graph 2000 and the graph 2050 show that, for both frame rates graphed in FIG. 20 (1 fps and 30 fps), and for all numbers of updates (e.g., from 2 to 24), both the mean and the median of absolute change in TSDF values is less than 0.1 and larger than 0.001.

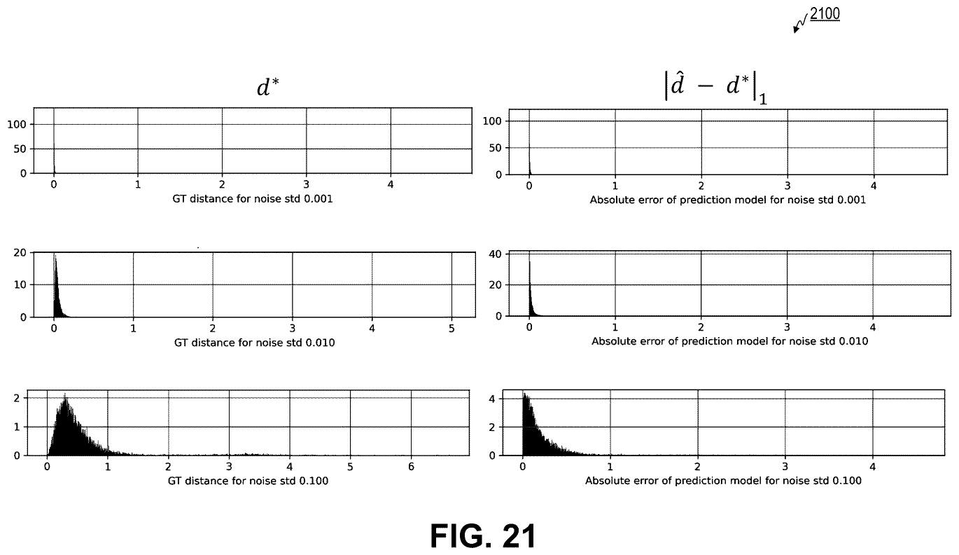

FIG. 21 is a graph diagram illustrating graphs 2100 of actual vertex distance (d*) and vertex distance estimation error (|\hat{d}−d*|₁), in accordance with some examples. The graphs 2100 represent a test by a test system having tested 60,000 pairs of TSDF volumes where a first TSDF value (t₁) (representing a previous TSDF value 1320 and/or a previous TSDF value 1705) was randomly and independently generated and the second TSDF value (t₂) (representing the updated TSDF value 1330 and/or the updated TSDF value 1710) was based on the first TSDF value plus a gaussian noise with 0 mean and σ standard deviation, following the equation below:

$${t}_{2} = {t}_{1} + σ \cdot n , n ∼ N ( 0 , 1 )$$

Based on the graph 2000 and the graph 2050 in FIG. 10, both the mean and the median of TSDF value changes is bounded between 0.001 and 0.1. Therefore, in generating the graphs 2100, the testing system uses a value of σ∈{0.001,0.01,0.1}. The graphs 2100 indicate that the error |\hat{d}−d*|₁ for all these 60,000 cases, and plotting distribution of the error. We also plot the distribution of the actual vertex distance (d*) calculated using the Marching cube algorithm and the nearest neighbor search/selection. The graphs 2100 show that the average errors for σ=0.001, 0.01, and 0.1 are 0.008, 0.042, and 0.251 respectively. Thus, the graphs 2100 show that the estimated vertex difference 1740 and/or estimated vertex difference 1840 (\hat{d}) generated using the neural network architecture 1700 and/or the neural network architecture 1800 provide an accurate estimate or prediction (\hat{d}) (e.g., estimated vertex difference 1740, estimated vertex difference 1840, estimated vertex difference for the comparison 1410) of the actual vertex difference (actual vertex distance) (d*) computed using the marching cube algorithm.

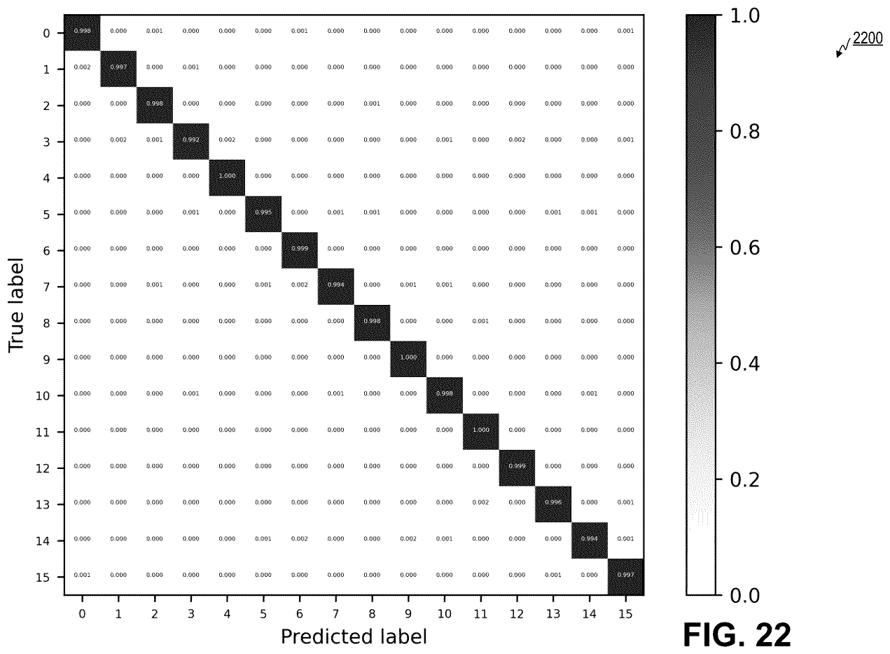

FIG. 22 is a heat map diagram 2200 illustrating true label for a given voxel relative to predicted label for the given voxel. Both axes of the heat map diagram 2200 refer to labels zero through 15. The values from zero to 15 along the axes of the heat map diagram 2200 represent the voxel configurations 1605-1680. For instance, in an illustrative example, zero on the axes of the heat map diagram 2200 represents the voxel configuration 1605, one on the axes of the heat map diagram 2200 represents the voxel configuration 1610, two on the axes of the heat map diagram 2200 represents the voxel configuration 1615, and so forth, with fifteen on the axes of the heat map diagram 2200 ultimately representing the voxel configuration 1680. The horizontal axis indicates which voxel configuration was estimated or predicted by the neural network architecture 1700 and/or the neural network architecture 1800 (e.g., by the CNN Layers 1 1715 and/or the CNN layers 1 1720). The vertical axis indicates which voxel configuration accurate as determined using the marching cube algorithm. The heat map diagram 2200 represents 340,000 tested cases. The heat map diagram 2200 illustrates that the estimation or prediction is accurate over 99% of the time for every voxel configuration, with certain voxel configurations even being accurate 100% of the time (the voxel configurations with labels 4, 9, and 11). The lowest accuracy was 99.2% for the voxel configuration with label 3, though even 99.2% is a high degree of accuracy. The heat map diagram 2200 shows an overall accuracy of voxel configuration classification of 99.65% across the 340,000 tested cases. The heat map diagram 2200 may be referred to as a confusion matrix. It should be understood that the graph 2000, the graph 2050, the graphs 2100, and the heat map diagram 2200 represent illustrative and non-limiting examples of results of the systems and methods described herein. In some examples, the systems and methods described herein may generate results fall within different ranges than those illustrated in FIGS. 20-22.

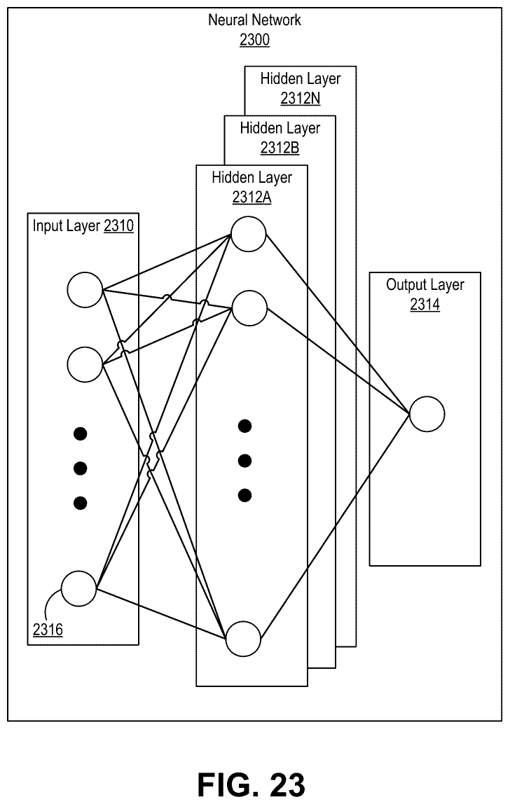

FIG. 23 is a block diagram illustrating an example of a neural network (NN) 2300 that can be used for 3D mesh reconstruction. The neural network 2300 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network. The neural network 2300 may be, and/or may include, an example of any of a neural network that generates the estimated vertex difference for the comparison 1410, the neural network architecture 1700, the neural network architecture 1800, any layers thereof (e.g., the CNN layers 1 1715, the CNN layers 1 1720, the CNN layers 2 1730, the fully connected layers 1735), any other machine learning models discussed herein, or a combination thereof.

An input layer 2310 of the neural network 2300 includes input data. The input data of the input layer 2310 can include image data, depth data, pose data, TSDF values, weight volume values, or a combination thereof. In some examples, the input data of the input layer 2310 can include the depth map 1305, the pose 1310, the previous TSDF values 1320, the previous weight volume values 1322, the updated TSDF values 1330, the updated weight volume values 1332, a predicted voxel configuration of the voxel configuration 1605-1680, the previous TSDF values 1705, the updated TSDF values 1710, the shared weights 1725, the predicted label of the heat map diagram 2200, or a combination thereof. In some examples, the input data of the input layer 2310 includes processed data that is to be processed further, such as various features, weights, intermediate data, output(s) of certain intermediate layer(s) or node(s), or a combination thereof.

The neural network 2300 includes multiple hidden layers 2312, 2312B, through 2312N. The hidden layers 2312, 2312B, through 2312N include “N” number of hidden layers, where “N” is an integer greater than or equal to one. The number of hidden layers can be made to include as many layers as needed for the given application. The neural network 2300 further includes an output layer 2314 that provides an output resulting from the processing performed by the hidden layers 2312, 2312B, through 2312N.

In some examples, the output layer 2314 can provide output data. The output data can include the estimated vertex difference for the comparison 1410, the comparison 1410 itself, a predicted voxel configuration of the voxel configuration 1605-1680, the shared weights 1725, the estimated vertex difference 1740, the estimated vertex difference 1840, the estimated vertex difference (\hat{d}) of the graphs 2100, the predicted label of the heat map diagram 2200, or a combination thereof.

The neural network 2300 is a multi-layer neural network of interconnected filters. Each filter can be trained to learn a feature representative of the input data. Information associated with the filters is shared among the different layers and each layer retains information as information is processed. In some cases, the neural network 2300 can include a feed-forward network, in which case there are no feedback connections where outputs of the network are fed back into itself. In some cases, the network 2300 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 2310 can activate a set of nodes in the first hidden layer 2312A. For example, as shown, each of the input nodes of the input layer 2310 can be connected to each of the nodes of the first hidden layer 2312A. The nodes of a hidden layer can transform the information of each input node by applying activation functions (e.g., filters) to this information. The information derived from the transformation can then be passed to and can activate the nodes of the next hidden layer 2312B, which can perform their own designated functions. Example functions include convolutional functions, downscaling, upscaling, data transformation, and/or any other suitable functions. The output of the hidden layer 2312B can then activate nodes of the next hidden layer, and so on. The output of the last hidden layer 2312N can activate one or more nodes of the output layer 2314, which provides a processed output image. In some cases, while nodes (e.g., node 2316) in the neural network 2300 are shown as having multiple output lines, a node has a single output and all lines shown as being output from a node represent the same output value.

In some cases, each node or interconnection between nodes can have a weight that is a set of parameters derived from the training of the neural network 2300. For example, an interconnection between nodes can represent a piece of information learned about the interconnected nodes. The interconnection can have a tunable numeric weight that can be tuned (e.g., based on a training dataset), allowing the neural network 2300 to be adaptive to inputs and able to learn as more and more data is processed.

In some aspects, training of one or more of the machine learning systems or neural networks described herein can be performed using online training (e.g., in some case on-device training), offline training, and/or various combinations of online and offline training. In some cases, online may refer to time periods during which the input data (e.g., such as the input data discussed with respect to the input layer 2310) is processed, for instance for generating output data (e.g., such as the input data discussed with respect to the output layer 2314). In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

The neural network 2300 is pre-trained to process the features from the data in the input layer 2310 using the different hidden layers 2312, 2312B, through 2312N in order to provide the output through the output layer 2314.

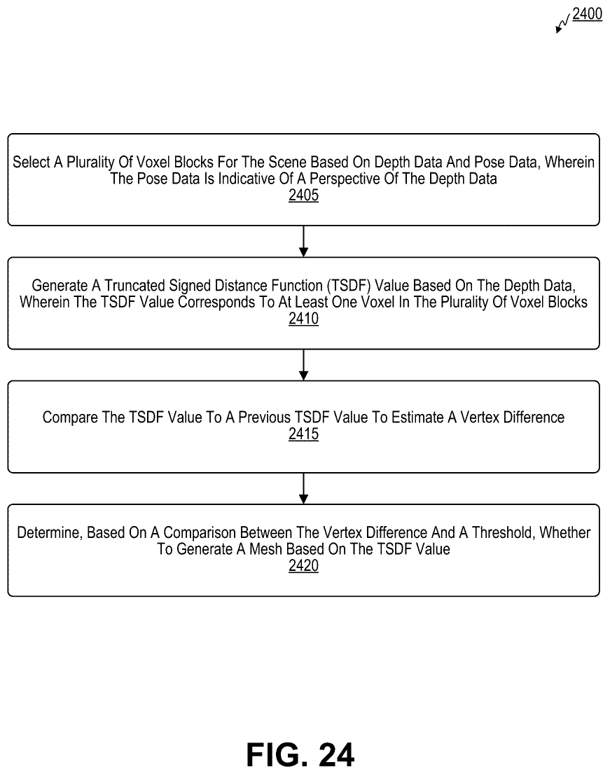

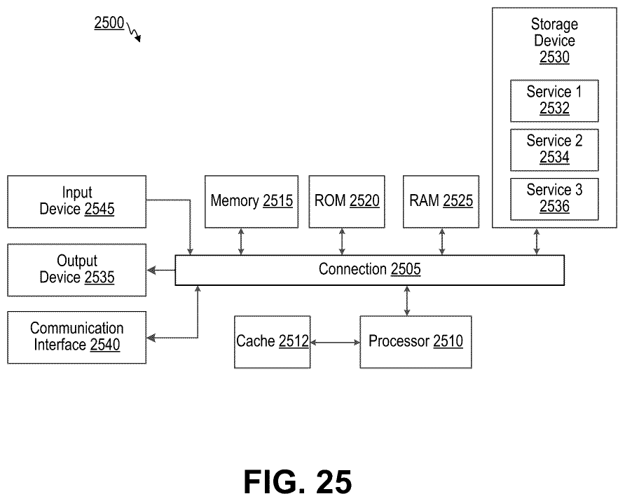

FIG. 24 is a flow chart illustrating an example of a process 2400 for 3D reconstruction of a scene. The process 2400 may also be described as a process for mesh difference estimation based on truncated signed distance function (TSDF) value comparison. The process 2400 can be performed by a 3D reconstruction system, which may include the image capture and processing system 100 of FIG. 1, the image capture device 105A of FIG. 1, the image processing device 105B of FIG. 1, image capture and processing system 200 of FIG. 2, the device 300 of FIG. 3, the 3D reconstruction system that performs the process 1300, the 3D reconstruction system that performs the process 1400, the neural network architecture 1700, the neural network architecture 1800, the neural network 2300, the computing system 2500 of FIG. 25, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, or a combination thereof. In some examples, process 2400 is performed by a component or system (e.g., a chipset, one or more processors such as one or more central processing units (CPUs), digital signal processors (DSPs), graphics processing units (GPUs), any combination thereof, and/or other type of processor(s), or other component or system) of the 3D reconstruction system. The operations of the process 2400 may be implemented as software components that are executed and run on one or more processors (e.g., processor 2510 of FIG. 25 or other processor(s)). Further, the transmission and reception of signals by the computing device in the process 2400 may be enabled, for example, by one or more antennas and/or one or more transceivers (e.g., wireless transceiver(s)).

At operation 2405, the 3D reconstruction system (or a component or subsystem thereof) is configured to, and can, select a plurality of voxel blocks (e.g., voxel block 600) for the scene based on depth data (e.g., depth data processed in operation 810, depth map 910, depth map 1305) and pose data (e.g., pose processed in operation 810, 6 DoF pose 920, pose 1310). The pose data is indicative of a perspective of the depth data (e.g., a perspective of a capture device that captures the depth data). Examples of the selection of the voxel blocks in operation 2405 include the scalable voxel block selection algorithm 900, the operation 940, the operation 960, operation 1020, the voxel block selection 1315, any other voxel block selection operations or processes discussed herein, or a combination thereof.

In some examples, the depth data includes a depth map (e.g., depth map 910, depth map 1305) that maps depth values to pixels in an image (e.g., a 2D image) of the scene.

At operation 2410, the 3D reconstruction system (or a component or subsystem thereof) is configured to, and can, generate a truncated signed distance function (TSDF) value based on the depth data. The TSDF value corresponds to at least one voxel in the plurality of voxel blocks. In some examples, generation of the TSDF value is performed using the depth integration 1325 of the 3D reconstruction system (e.g., as in the process 1300 and/or the process 1400). Examples of the TSDF value include the updated TSDF value 1330, the updated TSDF value 1710, the TSDF values for which changes are graphed in the graph 2000 and/or the graph 2050, another TSDF value discussed herein, or a combination thereof.

In some aspects, generating the TSDF value based on the depth data (as in operation 2410) includes generating the TSDF value (e.g., the updated TSDF value 1330) based on the depth data and also on any of: the previous TSDF value (e.g., previous TSDF value 1320), the pose data (e.g., pose 1310), a previous weight volume value associated with the previous TSDF value (e.g., previous weight volume value 1322), or a combination thereof. As an example, the generating of the updated TSDF value 1330 via the depth integration 1325 can be based on at least the depth map 1305, the pose 1310, the previous TSDF value 1320, the previous weight volume value 1322, or a combination thereof.

In some aspects, generating the TSDF value (as in operation 2410) includes processing the depth data and the pose data using a trained machine learning model (e.g., neural network 2300). In some aspects, the trained machine learning model is a deep learning (DL) model, and generating the TSDF value (as in operation 2410) includes performing DL-based regression using the DL model.

At operation 2415, the 3D reconstruction system (or a component or subsystem thereof) is configured to, and can, compare the TSDF value to a previous TSDF value to estimate a vertex difference. Examples of the previous TSDF value include the previous TSDF value 1320, the previous TSDF value 1705, the TSDF values for which changes are graphed in the graph 2000 and/or the graph 2050, another TSDF value discussed herein, or a combination thereof. Examples of the vertex difference include the estimated vertex difference 1740, the estimated vertex difference 1840, the estimated vertex difference for the comparison 1410, other vertex differences discussed herein, or a combination thereof. The vertex difference can be referred to as the vertex distance, the estimated vertex difference, the estimated vertex distance, the predicted vertex distance, the predicted vertex difference, or a combination thereof. The vertex difference can be a difference or distance in the 3D mesh domain, rather than the TSDF domain.

In some aspects, comparing the TSDF value to the previous TSDF value to estimate the vertex difference (as in operation 2415) includes applying a scaling factor to a difference between the TSDF value and the previous TSDF value to estimate the vertex difference. For instance, the scaling factor can include alpha (α) in the equation below:

$$d = ( α ( {t}_{1} - {t}_{2} ) + β )$$

In some aspects, comparing the TSDF value to the previous TSDF value to estimate the vertex difference (as in operation 2415) includes applying a linear regression model to a difference between the TSDF value and the previous TSDF value to estimate the vertex difference. For instance, the linear regression model can be based on the equation above. In the equation, d refers to a difference in the mesh domain (e.g., the vertex difference), t₁ refers to the previous TSDF value, t₂ refers to the TSDF value (e.g., updated TSDF value), and alpha (α) and beta (β) are adjustable parameters.

In some aspects, the previous TSDF value is associated with a previous mesh of the scene (e.g., previous 3D mesh reconstruction 1430). In some aspects, the previous TSDF value is based on previous depth data and/or previous pose data (e.g., that the previous 3D mesh reconstruction 1430 is also based on).

In some aspects, the 3D reconstruction system (or a component or subsystem thereof) is configured to, and can, generate a weight volume value (e.g., updated weight volume value 1332) based on at least one of the depth data (e.g., depth map 1305), the previous TSDF value (e.g., previous TSDF value 1320), or a previous weight volume value (e.g., previous weight volume value 1322) associated with the previous TSDF value. In some aspects, the vertex difference is identified (e.g., in operation 2415) also based on the weight volume value. For instance, in some examples, the updated weight volume value 1332 can be an input into the neural network architecture 1700, the neural network architecture 1800, the neural network 2300, a linear regression model, or another algorithm or model used to estimate the vertex difference.

In some aspects, the 3D reconstruction system (or a component or subsystem thereof) is configured to, and can, generate a second TSDF value based on the depth data. The TSDF value (generated in operation 2410) corresponds to a first corner of the at least one voxel, while the second TSDF value corresponds to a second corner of the at least one voxel (e.g., different corners of the voxel represented by the polygon 1505). In some aspects, the vertex difference is estimated (in operation 2415) also based on a comparison between the second TSDF value to a previous second TSDF value. For instance, in some examples, the estimated vertex difference is estimated (in operation 2415) based on comparisons between updated TSDF values and corresponding previous TSDF values for multiple points (e.g., multiple corners of one or more voxels and/or voxel blocks).

In some aspects, the vertex difference can be estimated (in operation 2415) based on a cloud-to-cloud distance metric, a cloud-to-mesh distance metric, a mesh-to-mesh difference, or a combination thereof. In some aspects, the vertex difference d* can be estimated (in operation 2415) based on one of either or both of the equations identified below:

$${d}^{*} = {\sum }_{v ∈ {m}_{2}} {\vert v - n ( v ) \vert}_{2} , n ( v ) = {min}_{{v}^{′} ∈ {m}_{1}} {\vert v - {v}^{′} \vert}_{2}$$

$${d}^{*} = {\sum }_{v ∈ {m}_{2}} d ( v ) , d ( v ) = {min}_{{t}^{′} ∈ {m}_{1}} {\vert v - P ( v \vert {t}^{′} ) \vert}_{2}$$

At operation 2420, the 3D reconstruction system (or a component or subsystem thereof) is configured to, and can, determine, based on a comparison (e.g., comparison 1410) between the vertex difference (e.g., estimated vertex difference 1740, estimated vertex difference 1840) and a threshold, whether to generate a mesh (e.g., 3D mesh reconstruction 1440) based on the TSDF value (e.g., whether to generate the 3D mesh reconstruction 1440 based on the updated TSDF value 1330).

In some aspects, the comparison (of operation 2420) indicates that the vertex difference is less than or equal to the threshold (e.g., that the threshold is greater than or equal to the vertex difference). In some aspects, based on the comparison indicating that the vertex difference is less than or equal to the threshold, the 3D reconstruction system (or a component or subsystem thereof) is configured to, and can, maintain a previous mesh (e.g., previous 3D mesh reconstruction 1430) of the scene in memory without generating the mesh based on the TSDF value. For instance, the comparison 1410 is an example of the comparison of operation 2420. If the comparison 1410 indicates that the vertex difference is less than the threshold, the process 1400 indicates that the 3D reconstruction system is to maintain the previous 3D mesh reconstruction 1430 in memory without generating the 3D mesh reconstruction 1440 based on the updated TSDF value 1330.

In some aspects, the comparison (of operation 2420) indicates that the vertex difference is greater than or equal to the threshold (e.g., that the threshold is less than or equal to the vertex difference). In some aspects, based on the comparison indicating that the vertex difference is greater than or equal to the threshold, the 3D reconstruction system (or a component or subsystem thereof) is configured to, and can, generate the mesh based on the TSDF value in response to the comparison indicating that the vertex difference is greater than (or equal to) the threshold. In some aspects, the 3D reconstruction system (or a component or subsystem thereof) is configured to, and can, write the mesh into memory (e.g., cache 2512, memory unit 2515, RAM 2525, storage device 2530).

In some aspects, comparing the TSDF value to the previous TSDF value to estimate the vertex difference (as in operation 2415) includes processing the TSDF value and the previous TSDF value using a trained machine learning model to estimate the vertex difference. In some aspects, the trained machine learning model is a neural network, such as the neural network architecture 1700, the neural network architecture 1800, the neural network 2300, another neural network discussed herein, or a combination thereof.

In some aspects, the 3D reconstruction system (or a component or subsystem thereof) is configured to, and can, generate the mesh based on the TSDF value in response to the comparison (of operation 2420) indicating that the vertex difference is greater than (or equal to) the threshold. In some aspects, the 3D reconstruction system (or a component or subsystem thereof) is configured to, and can, determine an actual vertex difference between the mesh (e.g., the 3D mesh reconstruction 1440) and a previous mesh (e.g., the previous 3D mesh reconstruction 1430). The previous TSDF value (e.g., previous TSDF value 1320, previous TSDF value 1705) is associated with the previous 3D mesh reconstruction 1430. In some aspects, the 3D reconstruction system (or a component or subsystem thereof) is configured to, and can, update (e.g., further train and/or retrain) the trained machine learning model based on a comparison between the actual vertex difference and the vertex difference. An example of the comparison between the actual vertex difference and the vertex difference is the error |\hat{d}−d*|₁ that is graphed in the graphs 2100 and compares actual vertex distance d* to estimated vertex difference \hat{d} (that is estimated in operation 2415).

In some aspects, the trained machine learning model includes at least a first layer and a second layer. The first layer is configured to categorize the at least one voxel into one of a plurality of predetermined voxel configurations to identify a predicted arrangement of at least one surface in the mesh. The second layer is configured to compare the predicted arrangement of the at least one surface in the mesh to a previous mesh. In some aspects, the first layer is one of a set of convolutional neural network (CNN) layers of the trained machine learning model. For instance, in an illustrative example, the first layer may be one of the first set of CNN layers (e.g., CNN Layers 1 1715 and CNN Layers 1 1720) and/or one of the second set of CNN layers (e.g., the CNN Layers 2 1730). In some aspects, the second layer is one of a set of convolutional neural network (CNN) layers of the trained machine learning model. For instance, in an illustrative example, the second layer may be one of the second set of CNN layers (e.g., the CNN Layers 2 1730). In some aspects, the second layer is one of a set of fully connected (FC) layers of the trained machine learning model. For instance, in an illustrative example, the second layer is one of the fully connected (FC) layers 1735.

In some examples, the process 2400 (and/or the process 1400) reduces computational resource usage, memory, bandwidth usage, and complexity considerably compared to the process 1300, as a new mesh is not necessarily computed and copied back every time the mesh extraction is scheduled if there is not a significant change in the scene (based on the comparison 1410). Since the process 1400, the neural network architecture 1700, the neural network architecture 1800, and/or the process 2400 use a data-centric approach, the 3D reconstruction system can incorporate any extraction, generation, and/or processing of a mesh into the learning pipeline to maintain and/or improve accuracy of vertex difference estimation for future vertex difference estimations. If there is no further processing of a mesh, in some examples, the 3D reconstruction system can run the logic of the marching cube and nearest neighbor search algorithms to compute the vertex difference.

The process 2400 generally describes the processing of a single voxel. In some examples, the 3D reconstruction system can run the same network (e.g., the network architecture 1700, the network architecture 1800, the neural network 2300) in batch-wise manner to process a group of voxels. In some examples, the 3D reconstruction system can also modify the network architecture (e.g., the network architecture 1700, the network architecture 1800, the neural network 2300) to process a voxel block (a block of voxels) and measure the overall mesh distance spanning space covered by the voxel block.

In some examples, supervision (e.g., explicit priors) during training of the network (e.g., the network architecture 1700, the network architecture 1800, the neural network 2300) may be used to regulate the learning process and reduce the error with respect to the true mesh distance d*.

In some examples, the inputs to the network (e.g., the network architecture 1700, the network architecture 1800, the neural network 2300) include TSDF values, and the network follows the order in which the TSDF values are input. In some examples, the network can include information identifying the location of edges of voxels and/or surfaces, and therefore of vertices in a mesh, and can process the TSDF values according to that information.

In some examples, the network (e.g., the network architecture 1700, the network architecture 1800, the neural network 2300) includes 1-dimensional (1D) CNN layers with window size one, ReLU, and fully connected layers. This configuration can help the network to run on a wider variety of device types, in some cases even on devices without specialized acceleration hardware for processing multi-dimensional layers.

In some examples, the weight volume values or counters (e.g., previous weight volume value 1322, updated weight volume value 1332) may serve as additional input(s) to the network (e.g., the network architecture 1700, the network architecture 1800, the neural network 2300). The weight volume values may provide valuable information about the changes in TSDF values, as the graph 2000 and the graph 2050 show that as the number of times a TSDF value for a given voxel (e.g., for a given corner of the voxel) is updated increases (e.g., as the weight volume value or counter increases), the change in TSDF values (and in some cases the vertex difference in the mesh domain) diminishes.

FIG. 25 is a block diagram illustrating an example of a computing system 2500, which may be employed for a scalable voxel block selection algorithm with a finite hardware cache. In particular, FIG. 25 illustrates an example of computing system 2500, which can be for example any computing device making up internal computing system, a remote computing system, a camera, or any component thereof in which the components of the system are in communication with each other using connection 2505. Connection 2505 can be a physical connection using a bus, or a direct connection into processor 2510, such as in a chipset architecture. Connection 2505 can also be a virtual connection, networked connection, or logical connection.

In some aspects, computing system 2500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2500 includes at least one processing unit (CPU or processor) 2510 and connection 2505 that communicatively couples various system components including system memory (e.g., memory unit 2515), such as read-only memory (ROM) 2520 and random access memory (RAM) 2525 to processor 2510. Computing system 2500 can include a cache 2512 of high-speed memory connected directly with, in close proximity to, or integrated as part of processor 2510.

Processor 2510 can include any general purpose processor and a hardware service or software service, such as services 2532, 2534, and 2536 stored in storage device 2530, configured to control processor 2510 as well as a special-purpose processor where software instructions are incorporated into the actual processor design. Processor 2510 may essentially be a completely self-contained computing system, containing multiple cores or processors, a bus, memory controller, cache, etc. A multi-core processor may be symmetric or asymmetric.

To enable user interaction, computing system 2500 includes an input device 2545, which can represent any number of input mechanisms, such as a microphone for speech, a touch-sensitive screen for gesture or graphical input, keyboard, mouse, motion input, speech, etc. Computing system 2500 can also include output device 2535, which can be one or more of a number of output mechanisms. In some instances, multimodal systems can enable a user to provide multiple types of input/output to communicate with computing system 2500.

Computing system 2500 can include communications interface 2540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2540 may also include one or more range sensors (e.g., LIDAR sensors, laser range finders, RF radars, ultrasonic sensors, and infrared (IR) sensors) configured to collect data and provide measurements to processor 2510, whereby processor 2510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2540 may also include one or more Global Navigation Satellite System (GNSS) receivers or transceivers that are used to determine a location of the computing system 2500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2530 can include software services, servers, services, etc., that when the code that defines such software is executed by the processor 2510, it causes the system to perform a function. In some aspects, a hardware service that performs a particular function can include the software component stored in a computer-readable medium in connection with the necessary hardware components, such as processor 2510, connection 2505, output device 2535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for three-dimensional reconstruction (3DR) of a scene, the apparatus comprising: a memory; and one or more processors coupled to the memory, the one or more processors configured to: select a plurality of voxel blocks for the scene based on depth data and pose data, wherein the pose data is indicative of a perspective of the depth data; generate a truncated signed distance function (TSDF) value based on the depth data, wherein the TSDF value corresponds to at least one voxel in the plurality of voxel blocks; compare the TSDF value to a previous TSDF value to estimate a vertex difference; and determine, based on a comparison between the vertex difference and a threshold, whether to generate a mesh based on the TSDF value.

Aspect 2. The apparatus of Aspect 1, wherein the previous TSDF value is based on previous depth data and previous pose data, and wherein the previous TSDF value is associated with a previous mesh of the scene.

Aspect 3. The apparatus of Aspect 1 or Aspect 2, wherein the at least one processor is configured to: maintain a previous mesh of the scene in memory without generating the mesh based on the TSDF value in response to the comparison indicating that the vertex difference is less than the threshold, wherein the previous TSDF value is associated with the previous mesh.

Aspect 4. The apparatus of any one of Aspect 1 to Aspect 3, wherein the at least one processor is configured to: generate the mesh based on the TSDF value in response to the comparison indicating that the vertex difference is greater than the threshold.

Aspect 5. The apparatus of Aspect 4, wherein the at least one processor is configured to: write the mesh into memory.

Aspect 6. The apparatus of any one of Aspect 1 to Aspect 5, wherein, to compare the TSDF value to the previous TSDF value to estimate the vertex difference, the at least one processor is configured to apply a scaling factor to a difference between the TSDF value and the previous TSDF value to estimate the vertex difference.

Aspect 7. The apparatus of any one of Aspect 1 to Aspect 6, wherein, to compare the TSDF value to the previous TSDF value to estimate the vertex difference, the at least one processor is configured to apply a linear regression model to a difference between the TSDF value and the previous TSDF value to estimate the vertex difference.

Aspect 8. The apparatus of any one of Aspect 1 to Aspect 7, wherein, to compare the TSDF value to the previous TSDF value to estimate the vertex difference, the at least one processor is configured to process the TSDF value and the previous TSDF value using a trained machine learning model to estimate the vertex difference.

Aspect 9. The apparatus of Aspect 8, wherein the trained machine learning model is a neural network.

Aspect 10. The apparatus of Aspect 8 or Aspect 9, wherein the at least one processor is configured to: generate the mesh based on the TSDF value in response to the comparison indicating that the vertex difference is greater than the threshold; determine an actual vertex difference between the mesh and a previous mesh, wherein the previous TSDF value is associated with the previous mesh; and update the trained machine learning model based on a comparison between the actual vertex difference and the vertex difference.

Aspect 11. The apparatus of any one of Aspect 8 to Aspect 10, wherein the trained machine learning model includes at least a first layer and a second layer, wherein the first layer is configured to categorize the at least one voxel into one of a plurality of predetermined voxel configurations to identify a predicted arrangement of at least one surface in the mesh, and wherein the second layer is configured to compare the predicted arrangement of the at least one surface in the mesh to a previous mesh.

Aspect 12. The apparatus of Aspect 11, wherein the first layer is one of a set of convolutional neural network (CNN) layers of the trained machine learning model.

Aspect 13. The apparatus of Aspect 11 or Aspect 12, wherein the second layer is one of a set of convolutional neural network (CNN) layers of the trained machine learning model.

Aspect 14. The apparatus of any one of Aspect 11 to Aspect 13, wherein the second layer is one of a set of fully connected (FC) layers of the trained machine learning model.

Aspect 15. The apparatus of any one of Aspect 1 to Aspect 14, wherein the depth data includes a depth map that maps depth values to pixels in an image of the scene.

Aspect 16. The apparatus of any one of Aspect 1 to Aspect 15, wherein, to generate the TSDF value based on the depth data, the at least one processor is configured to generate the TSDF value based on the depth data and the previous TSDF value.

Aspect 17. The apparatus of any one of Aspect 1 to Aspect 16, wherein, to generate the TSDF value based on the depth data, the at least one processor is configured to generate the TSDF value based on the depth data and the pose data.

Aspect 18. The apparatus of any one of Aspect 1 to Aspect 17, wherein, to generate the TSDF value based on the depth data, the at least one processor is configured to generate the TSDF value based on the depth data and a previous weight volume value associated with the previous TSDF value.

Aspect 19. The apparatus of any one of Aspect 1 to Aspect 18, wherein the at least one processor is configured to: generate a weight volume value based on at least one of the depth data, the previous TSDF value, or a previous weight volume value associated with the previous TSDF value; wherein the vertex difference is also based on the weight volume value.

Aspect 20. The apparatus of any one of Aspect 1 to Aspect 19, wherein the at least one processor is configured to: generate a second TSDF value based on the depth data, wherein the TSDF value corresponds to a first corner of the at least one voxel, wherein the second TSDF value corresponds to a second corner of the at least one voxel, wherein the vertex difference is also based on a comparison between the second TSDF value to a previous second TSDF value.

Aspect 21. The apparatus of any one of Aspect 1 to Aspect 20, wherein, to generate the TSDF value, the at least one processor is configured to process the depth data and the pose data using a trained machine learning model.

Aspect 22. The apparatus of Aspect 21, wherein the trained machine learning model is a deep learning (DL) model, and wherein, to generate the TSDF value, the at least one processor is configured to perform DL-based regression using the DL model.

Aspect 23. The apparatus of any one of Aspect 1 to Aspect 22, wherein the apparatus includes at least one of a head-mounted display (HMD), a mobile handset, or a wireless communication device.

Aspect 24. A method for three-dimensional reconstruction (3DR) of a scene, the method comprising: selecting a plurality of voxel blocks for the scene based on depth data and pose data, wherein the pose data is indicative of a perspective of the depth data; generating a truncated signed distance function (TSDF) value based on the depth data, wherein the TSDF value corresponds to at least one voxel in the plurality of voxel blocks; comparing the TSDF value to a previous TSDF value to estimate a vertex difference; and determining, based on a comparison between the vertex difference and a threshold, whether to generate a mesh based on the TSDF value.

Aspect 25. The method of Aspect 24, wherein the previous TSDF value is based on previous depth data and previous pose data, and wherein the previous TSDF value is associated with a previous mesh of the scene.

Aspect 26. The method of Aspect 24 or Aspect 25, further comprising: maintaining a previous mesh of the scene in memory without generating the mesh based on the TSDF value in response to the comparison indicating that the vertex difference is less than the threshold, wherein the previous TSDF value is associated with the previous mesh.

Aspect 27. The method of any one of Aspect 24 to Aspect 26, further comprising: generating the mesh based on the TSDF value in response to the comparison indicating that the vertex difference is greater than the threshold.

Aspect 28. The method of Aspect 27, further comprising: writing the mesh into memory.

Aspect 29. The method of any one of Aspect 24 to Aspect 28, wherein comparing the TSDF value to the previous TSDF value to estimate the vertex difference includes applying a scaling factor to a difference between the TSDF value and the previous TSDF value to estimate the vertex difference.

Aspect 30. The method of any one of Aspect 24 to Aspect 29, wherein comparing the TSDF value to the previous TSDF value to estimate the vertex difference includes applying a linear regression model to a difference between the TSDF value and the previous TSDF value to estimate the vertex difference.

Aspect 31. The method of any one of Aspect 24 to Aspect 30, wherein comparing the TSDF value to the previous TSDF value to estimate the vertex difference includes processing the TSDF value and the previous TSDF value using a trained machine learning model to estimate the vertex difference.

Aspect 32. The method of Aspect 31, wherein the trained machine learning model is a neural network.

Aspect 33. The method of Aspect 31 or Aspect 32, further comprising: generating the mesh based on the TSDF value in response to the comparison indicating that the vertex difference is greater than the threshold; determining an actual vertex difference between the mesh and a previous mesh, wherein the previous TSDF value is associated with the previous mesh; and updating the trained machine learning model based on a comparison between the actual vertex difference and the vertex difference.

Aspect 34. The method of any one of Aspect 31 to Aspect 33, wherein the trained machine learning model includes at least a first layer and a second layer, wherein the first layer is configured to categorize the at least one voxel into one of a plurality of predetermined voxel configurations to identify a predicted arrangement of at least one surface in the mesh, and wherein the second layer is configured to compare the predicted arrangement of the at least one surface in the mesh to a previous mesh.

Aspect 35. The method of Aspect 34, wherein the first layer is one of a set of convolutional neural network (CNN) layers of the trained machine learning model.

Aspect 36. The method of Aspect 34 or Aspect 35, wherein the second layer is one of a set of convolutional neural network (CNN) layers of the trained machine learning model.

Aspect 37. The method of any one of Aspect 34 to Aspect 36, wherein the second layer is one of a set of fully connected (FC) layers of the trained machine learning model.

Aspect 38. The method of any one of Aspect 24 to Aspect 37, wherein the depth data includes a depth map that maps depth values to pixels in an image of the scene.

Aspect 39. The method of any one of Aspect 24 to Aspect 38, wherein generating the TSDF value based on the depth data includes generating the TSDF value based on the depth data and the previous TSDF value.

Aspect 40. The method of any one of Aspect 24 to Aspect 39, wherein generating the TSDF value based on the depth data includes generating the TSDF value based on the depth data and the pose data.

Aspect 41. The method of any one of Aspect 24 to Aspect 40, wherein generating the TSDF value based on the depth data includes generating the TSDF value based on the depth data and a previous weight volume value associated with the previous TSDF value.

Aspect 42. The method of any one of Aspect 24 to Aspect 41, further comprising: generating a weight volume value based on at least one of the depth data, the previous TSDF value, or a previous weight volume value associated with the previous TSDF value; wherein the vertex difference is also based on the weight volume value.

Aspect 43. The method of any one of Aspect 24 to Aspect 42, further comprising: generating a second TSDF value based on the depth data, wherein the TSDF value corresponds to a first corner of the at least one voxel, wherein the second TSDF value corresponds to a second corner of the at least one voxel, wherein the vertex difference is also based on a comparison between the second TSDF value to a previous second TSDF value.

Aspect 44. The method of any one of Aspect 24 to Aspect 43, wherein generating the TSDF value includes processing the depth data and the pose data using a trained machine learning model.

Aspect 45. The method of Aspect 44, wherein the trained machine learning model is a deep learning (DL) model, and wherein generating the TSDF value includes performing DL-based regression using the DL model.

Aspect 46. The method of any one of Aspect 24 to Aspect 45, wherein an apparatus performs the method, wherein the apparatus includes at least one of a head-mounted display (HMD), a mobile handset, or a wireless communication device.

Aspect 47. A non-transitory computer-readable medium having stored thereon instructions that, when executed by one or more processors, cause the one or more processors to perform operations according to any of Aspects 1 to 46.

Aspect 48. An apparatus for imaging, the apparatus comprising one or more means for performing operations according to any of Aspects 1 to 46.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for three-dimensional reconstruction (3DR) of a scene, the apparatus comprising:
at least one memory; and
at least one processor coupled to the at least one memory and configured to:
select a plurality of voxel blocks for the scene based on depth data and pose data, wherein the pose data is indicative of a perspective of the depth data;
generate a truncated signed distance function (TSDF) value based on the depth data, wherein the TSDF value corresponds to at least one voxel in the plurality of voxel blocks;
compare the TSDF value to a previous TSDF value to estimate a vertex difference; and
determine, based on a comparison between the vertex difference and a threshold, whether to generate a mesh based on the TSDF value.

2. The apparatus of claim 1, wherein the previous TSDF value is based on previous depth data and previous pose data, and wherein the previous TSDF value is associated with a previous mesh of the scene.

3. The apparatus of claim 1, wherein the at least one processor is configured to:
maintain a previous mesh of the scene in the at least one memory without generating the mesh based on the TSDF value in response to the comparison indicating that the vertex difference is less than the threshold, wherein the previous TSDF value is associated with the previous mesh.

4. The apparatus of claim 1, wherein the at least one processor is configured to:
generate the mesh based on the TSDF value in response to the comparison indicating that the vertex difference is greater than the threshold; and
write the mesh into the at least one memory.

5. The apparatus of claim 1, wherein, to compare the TSDF value to the previous TSDF value to identify the vertex difference, the at least one processor is configured to apply a scaling factor to a difference between the TSDF value and the previous TSDF value to estimate the vertex difference.

6. The apparatus of claim 1, wherein, to compare the TSDF value to the previous TSDF value to identify the vertex difference, the at least one processor is configured to apply a linear regression model to a difference between the TSDF value and the previous TSDF value to estimate the vertex difference.

7. The apparatus of claim 1, wherein, to compare the TSDF value to the previous TSDF value to identify the vertex difference, the at least one processor is configured to process the TSDF value and the previous TSDF value using a trained machine learning model to identify the vertex difference.

8. The apparatus of claim 7, wherein the at least one processor is configured to:
generate the mesh based on the TSDF value in response to the comparison indicating that the vertex difference is greater than the threshold;
determine an actual vertex difference between the mesh and a previous mesh, wherein the previous TSDF value is associated with the previous mesh; and
update the trained machine learning model based on a comparison between the actual vertex difference and the vertex difference.

9. The apparatus of claim 8, wherein the trained machine learning model includes at least a first layer and a second layer, wherein the first layer is configured to categorize the at least one voxel into one of a plurality of predetermined voxel configurations to identify a predicted arrangement of at least one surface in the mesh, and wherein the second layer is configured to compare the predicted arrangement of the at least one surface in the mesh to a previous mesh.

10. The apparatus of claim 9, wherein the first layer is one of a set of convolutional neural network (CNN) layers of the trained machine learning model.

11. The apparatus of claim 9, wherein the second layer is one of a set of convolutional neural network (CNN) layers of the trained machine learning model.

12. The apparatus of claim 9, wherein the second layer is one of a set of fully connected (FC) layers of the trained machine learning model.

13. The apparatus of claim 1, wherein the depth data includes a depth map that maps depth values to pixels in an image of the scene.

14. The apparatus of claim 1, wherein, to generate the TSDF value based on the depth data, the at least one processor is configured to generate the TSDF value based on the depth data and the previous TSDF value.

15. The apparatus of claim 1, wherein, to generate the TSDF value based on the depth data, the at least one processor is configured to generate the TSDF value based on the depth data and the pose data.

16. The apparatus of claim 1, wherein, to generate the TSDF value based on the depth data, the at least one processor is configured to generate the TSDF value based on the depth data and a previous weight volume value associated with the previous TSDF value.

17. The apparatus of claim 1, wherein the at least one processor is configured to:
generate a weight volume value based on at least one of the depth data, the previous TSDF value, or a previous weight volume value associated with the previous TSDF value;
wherein the vertex difference is also based on the weight volume value.

18. The apparatus of claim 1, wherein the at least one processor is configured to:
generate a second TSDF value based on the depth data, wherein the TSDF value corresponds to a first corner of the at least one voxel, wherein the second TSDF value corresponds to a second corner of the at least one voxel, wherein the vertex difference is also based on a comparison between the second TSDF value to a previous second TSDF value.

19. The apparatus of claim 1, wherein, to generate the TSDF value, the at least one processor is configured to process the depth data and the pose data using a trained machine learning model.

20. A method for three-dimensional reconstruction (3DR) of a scene, the method comprising:
selecting a plurality of voxel blocks for the scene based on depth data and pose data, wherein the pose data is indicative of a perspective of the depth data;
generating a truncated signed distance function (TSDF) value based on the depth data, wherein the TSDF value corresponds to at least one voxel in the plurality of voxel blocks;
comparing the TSDF value to a previous TSDF value to estimate a vertex difference; and
determining, based on a comparison between the vertex difference and a threshold, whether to generate a mesh based on the TSDF value.
